(19) United States
(12) Patent Application Publication
(10) Pub. No.: US 2026/0014540 A1
(43) Pub. Date: Jan. 15, 2026

(54) MXENE NANOSHEET INK FOR PALLADIUM RECOVERY AND ITS MANUFACTURING METHOD, PALLADIUM RECOVERY METHOD USING MXENE NANOSHEET INK, AND ELECTROCHEMICAL CATALYST USING RECOVERED PALLADIUM AND ITS MANUFACTURING METHOD

(71) Applicant: KOREA INSTITUTE OF SCIENCE AND TECHNOLOGY, Seoul (KR)

(72) Inventors: Jae Woo CHOI, Seoul (KR); Jin Young KIM, Seoul (KR); Seok Won HONG, Seoul (KR); Jong Hyun JANG, Seoul (KR); Youngkyun JUNG, Seoul (KR); Sujin YOON, Seoul (KR); Shi-Hyun SEOK, Seoul (KR); Minki JUN, Seoul (KR)

(21) Appl. No.: 19/005,714

(22) Filed: Dec. 30, 2024

(30) Foreign Application Priority Data
Jul. 10, 2024 (KR) 10-2024-0090813

(51) Int. Cl. B01J 20/02; B01J 20/28; B01J 20/292; B01J 20/30; B82Y 40/00; C01B 32/921

(52) U.S. Cl. CPC B01J 20/0274; B01J 20/0211; B01J 20/28011; B01J 20/28054; B01J 20/292; B01J 20/3085; C01B 32/921; B82Y 40/00

(57) ABSTRACT

The present invention relates to a MXene nanosheet ink for palladium recovery, a method of manufacturing the same, a method of recovering palladium using a MXene nanosheet ink, an electrochemical catalyst using recovered palladium, and a method of manufacturing the same that are capable of significantly improving the recovery efficiency of palladium ions in water.

### CROSS REFERENCE TO RELATED APPLICATION

The present application claims priority to Korean Patent Application No. 10-2024-0090813, filed on Jul. 10, 2024, the entire contents of which are incorporated herein for all purposes by this reference.

### BACKGROUND OF THE INVENTION

### Field of the Invention

The present invention relates to a MXene nanosheet ink for palladium recovery, a method of manufacturing the same, a method of recovering palladium using a MXene nanosheet ink, an electrochemical catalyst using recovered palladium, and a method of manufacturing the same, more specifically, to a MXene nanosheet ink for palladium recovery, a method of manufacturing the same, a method of recovering palladium using a MXene nanosheet ink, an electrochemical catalyst using recovered palladium, and a method of manufacturing the same that are capable of significantly improving the recovery efficiency of palladium ions in water, based on the adsorption mechanism of palladium ions through electrostatic attraction and the reduction mechanism of palladium ions via a redox reaction between palladium ions and MXene nanosheets.

### [Description of Government-Sponsored Research]

This invention was carried out with the support of the Ministry of Trade, Industry and Energy under a research project of Unique Project identification number: 1415186651 and Project identification number: 20213030030260 titled “Development of Lightweight Fuel Cell System for Air Mobility”, as part of the research project of “Development of new and renewable energy core technology (R&D)” managed by the Korea Energy Technology Evaluation and Planning from Jan. 1 to Dec. 31, 2023.

This invention was carried out with the support of the Ministry of Science and ICT under a research project of Unique Project identification number: 2710013936 and Project identification number: 2021M3I3A1082879 titled “Research of key element technologies for highly efficient, 100 cm² photoelectrochemical cell-based water splitting”, as part of the research project of “Development of future hydrogen source technology” managed by the National Research Foundation of Korea from Jan. 1 to Dec. 31, 2024.

This invention was carried out with the support of the Ministry of Science and ICT under a research project of Unique Project identification number: 2710016184 and Project identification number: 2020M3H4A3106366 titled “Developing customized module to enhance applicability of reactive filter under extreme environment”, as part of the research project of “Development of Nano material technology” managed by the National Research Foundation of Korea from Jan. 1 to Dec. 31, 2024.

### DESCRIPTION OF THE RELATED ART

Palladium (Pd) serves as an important catalyst in various cross-coupling reactions. In addition, palladium plays a pivotal role as a catalyst in the hydrogen evolution reaction (HER) for hydrogen purification and storage. Meanwhile, palladium has limited reserves, and its mining and refining processes consume significant amounts of energy and has negative environmental impacts, including large amounts of carbon dioxide emissions. For these reasons, the regeneration of used palladium is being promoted.

Methods of recovering used palladium may be considered, including adsorption, membrane filtration, precipitation, and electrochemical treatment. Among these, the method of recovering palladium using regenerable adsorbents is highly effective in terms of safety, simplicity, and recovery performance. Palladium adsorbents such as metal-organic frameworks (MOFs), MXene, polymers, metal oxides, silica-based adsorbents, and carbon-based adsorbents with high specific surface areas and functional groups have been proposed.

Among these, MXene nanosheets, which are two-dimensional transition metal carbides/nitrides, have a high specific surface area and sufficient surface activity, making them notable as metal ion adsorbents (refer to U.S. patent Ser. No. 10/933,399, Patent Document 1). The surface functional groups present on the MXene surface facilitate the recovery of metals from aqueous solutions. However, the practical application of MXene nanosheets for metal recovery faces challenges, such as the difficulty of recovering MXene nanosheets due to their very small size and the potential for secondary environmental pollution caused by their release.

To practicalize MXene nanosheets, immobilizing MXene nanosheets onto sheets, beads, or fibers with a certain area may be considered. However, this approach has drawbacks, such as reduced adsorption efficiency due to the increased weight of the adsorbent and the complexity of the manufacturing process.

As an alternative, a method of recovering palladium in water using MXene flakes with a layered structure of MXene nanosheets has been proposed (refer to “Removal of radioactive palladium based on novel 2D titanium carbides,” Wanjun Mu et al., Chemical Engineering Journal, Volume 358, 15 Feb. 2019, Pages 283-290, Non-Patent Document 1).

The technology disclosed in Non-Patent Document 1 describes that the palladium adsorption capacity of MXene flakes can be improved by applying an HF etching temperature of 45° C. during the process of manufacturing MXene flakes by etching MAX with HF. However, the maximum adsorption capacity of MXene flakes according to Non-Patent Document 1 is only 184.56 mg/g, which is due to the MXene flake structure hindering the diffusion of Pd ions.

### SUMMARY OF THE INVENTION

The present disclosure has been made in an effort to solve the above-mentioned problems, and an object of the present invention is to provide a MXene nanosheet ink for palladium recovery, a method of manufacturing the same, a method of recovering palladium using a MXene nanosheet ink, an electrochemical catalyst using recovered palladium, and a method of manufacturing the same that are capable of significantly improving the recovery efficiency of palladium ions in water, based on the adsorption mechanism of palladium ions through electrostatic attraction and the reduction mechanism of palladium ions via a redox reaction between palladium ions and MXene nanosheets.

To solve the aforementioned objects, there is provided a MXene nanosheet ink for palladium recovery, which is a solution in which MXene nanosheets of a chemical formula below are dispersed, in which a zeta potential (ζ) of the MXene nanosheets is 0 mV or higher in an acidic solution with a pH of 7 or below.

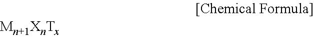

(where M is a transition metal, X is carbon and/or nitrogen, T is a surface functional group and is at least one selected from —O, —F, —OH, and —Cl, and n is an integer from 1 to 4).

In an acidic solution of pH 4 to 5, the zeta potential (ζ) of the MXene nanosheets exhibits 20 mV or higher.

In an acidic solution of pH of 4 to 5, the surface functional groups present on a surface of the MXene nanosheets are protonated and saturated by hydrogen ions (H⁺).

In an acidic solution of pH of 4 or lower, the surface functional groups present on a surface of the MXene nanosheets are protonated and saturated by hydrogen ions (H⁺), and the zeta potential (ζ) remains constant upon pH decrease.

The chemical formula is Ti₃C₂Tₓ.

The MXene nanosheet ink has a dispersion concentration of 2 g/L or less.

A maximum adsorption capacity of the MXene nanosheet ink for Pd2+ is 800 mg/g or more.

A maximum adsorption capacity of the MXene nanosheet ink for Pd2+ is 1000 mg/g or more.

A maximum adsorption capacity of the MXene nanosheet ink for Pd2+ is 1900 mg/g or more.

There is provided a method of manufacturing a MXene nanosheet ink for palladium recovery, according to the present invention. The method includes: preparing MXene flakes by reacting MAX with a strong acid solution; exfoliating the MXene flakes into MXene nanosheets; and dispersing the MXene nanosheets in a solution to manufacture a MXene nanosheet ink, in which the MXene nanosheets are represented by a chemical formula below and exhibit a zeta potential (ζ) of 0 mV or higher in an acidic solution of pH of 7 or less.

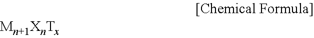

(where M is a transition metal, X is carbon and/or nitrogen, T is a surface functional group and is at least one selected from —O, —F, —OH, and —Cl, and n is an integer from 1 to 4).

The chemical formula is Ti₃C₂Tₓ.

In the preparing of MXene flakes by reacting MAX with a strong acid solution, a surface functional group density is adjusted such that the MXene nanosheets exhibit a zeta potential (ζ) of 0 mV or higher in an acidic solution of pH 7 or less.

In the preparing of MXene flakes by reacting MAX with a strong acid solution, a surface functional group density is adjusted such that the MXene nanosheets exhibit a zeta potential (ζ) of 20 mV or higher in an acidic solution of pH 4 to 5.

In the preparing of MXene flakes by reacting MAX with a strong acid solution, a surface functional group density on the MXene nanosheets is adjusted such that, in an acidic solution of pH of 4 or less, the surface functional groups present on the surface of MXene nanosheets are protonated and saturated by hydrogen ions (H⁺).

The surface functional group density is adjusted by controlling a concentration of the strong acid solution.

The strong acid solution is a diluted solution of hydrofluoric acid (HF) or hydrochloric acid (HCl).

The strong acid solution is a diluted solution of hydrofluoric acid (HF) with a concentration of 5 to 25%.

There is provided a method of recovering palladium using a MXene nanosheet ink, according to the present invention. The method includes: introducing a MXene nanosheet ink into an acidic solution including Pd²⁺, in which the MXene nanosheet ink is a solution in which MXene nanosheets are dispersed.

Pd²⁺ forms a palladium-anion complex by combining with anions in the acidic solution, and the palladium-anion complex is adsorbed onto a surface of positively charged MXene nanosheets through electrostatic attraction.

Pd²⁺ is reduced to palladium nanoparticles through a redox reaction between the Pd²⁺ adsorbed on the MXene nanosheets and the MXene nanosheets.

Electrostatic attraction between the anionic palladium nanoparticles and the positively charged MXene nanosheets causes the MXene nanosheets to aggregate and precipitate.

The MXene nanosheet ink is introduced into the acidic solution at a concentration of 0.3 g/L.

The acidic solution includes other metal ions.

There is provided an electrochemical catalyst using recovered palladium, according to the present invention. The electrochemical catalyst includes: a conductive electrode; and a palladium nanoparticle-immobilized MXene nanosheet aggregate coated on a surface of the electrode, in which the palladium nanoparticle-immobilized MXene nanosheet aggregate is recovered using the method of recovering palladium using a MXene nanosheet ink.

The electrochemical catalyst further includes an ion-conductive binder that physically binds the palladium nanoparticle-immobilized MXene nanosheet aggregate, and mediates ion conduction between the palladium nanoparticles.

The ion-conductive binder is composed of a perfluorosulfonic acid ionomer.

The electrode is composed of a carbon-based conductive material.

There is provided a method of manufacturing an electrochemical catalyst using recovered palladium, according to the present invention. The method includes: preparing a palladium nanoparticle-immobilized MXene nanosheet aggregate, recovered by the method of recovering palladium using a MXene nanosheet ink; and coating the palladium nanoparticle-immobilized MXene nanosheet aggregate onto a surface of a conductive electrode.

The palladium nanoparticle-immobilized MXene nanosheet aggregate is mixed with an ion-conductive binder, and a mixture of the palladium nanoparticle-immobilized MXene nanosheet aggregate and the ion-conductive binder is coated onto the surface of the conductive electrode.

The MXene nanosheet ink for palladium recovery and method of manufacturing the same, the palladium recovery method using MXene nanosheet ink, and the electrochemical catalyst using the recovered palladium along with method of manufacturing the same according to the present invention have the following effects.

Palladium ions present in the solution can be recovered with 100% efficiency through the electrostatic attraction between palladium-anion complexes and MXene nanosheets. In addition, the adsorbed palladium ions are reduced to palladium nanoparticles through a redox reaction between the palladium ions and MXene nanosheets. Electrostatic attraction between the palladium nanoparticles and MXene nanosheets causes the MXene nanosheets to aggregate to each other and precipitate, enabling very easy recovery of the palladium-adsorbed MXene nanosheets.

Moreover, even in environments where other metal ions coexist, the selectivity for palladium ions is exceptionally superior.

Further, the palladium-adsorbed MXene nanosheets can be utilized as electrochemical catalysts, such as catalysts for hydrogen evolution reactions, demonstrating excellent electrochemical properties.

### BRIEF DESCRIPTION OF THE DRAWINGS

FIG. 1 is a process schematic view for describing a method of manufacturing MXene nanosheets according to an embodiment of the present invention.

FIG. 2 is an actual photograph of Ti₃C₂Tₓ nanosheet ink prepared according to Experimental Example 1.

FIG. 3 illustrates the results of measuring the specific surface areas of MAX (Ti₃AlC₂) powder, Ti₃C₂Tₓ flakes, and Ti₃C₂Tₓ nanosheets.

FIG. 4 illustrates the results of measuring the hydrodynamic radius (H_{R}) of Ti₃C₂Tₓ nanosheets according to HF concentration.

FIG. 5 illustrates the experimental results of the zeta potential (ζ) of Ti₃C₂Tₓ nanosheets according to HF concentration.

FIG. 6 illustrates the experimental results of the adsorption capacity (ge) according to the amount of Ti₃C₂Tₓ nanosheets introduced.

FIG. 7 illustrates the experimental results of the adsorption capacity (ge) according to pH changes.

FIG. 8A illustrates the experimental results of the recovery rates of Ti₃C₂Tₓ nanosheets and carbon black (CB) according to the initial concentration (Ci) of palladium.

FIG. 8B illustrates the experimental results of changes in the hydrodynamic radius (H_{R}) of Ti₃C₂Tₓ nanosheets and carbon black (CB) according to reaction time.

FIG. 9 illustrates the isothermal adsorption curve of Ti₃C₂Tₓ nanosheet ink for Pd²⁺.

FIG. 10 is a reference view summarizing the maximum adsorption capacity (qm) and adsorption equilibrium time for each Pd adsorbent.

FIG. 11 illustrates the experimental results of the selectivity of Ti₃C₂Tₓ nanosheets according to HF concentration.

FIG. 12 illustrates the actual photographs, SEM images, and SEM-EDS analysis results for a spent Pd catalyst.

FIG. 13 illustrates the experimental results of the Pd²⁺ recovery rate from waste liquid including the actual used spent Pd catalyst.

FIG. 14 is a FESEM image of Pd@Ti₃C₂Tₓ.

FIGS. 15A, 15B, 15C, 15D, 15E, 15F and 15G illustrate the analysis results for describing the mechanism involved in palladium recovery by Ti₃C₂Tₓ nanosheets.

FIG. 16 illustrates the experimental results of changes in palladium recovery rates according to the number of adsorption-desorption cycles.

FIG. 17 is an optical microscope image of palladium desorbed from Pd@Ti₃C₂Tₓ nanosheets.

FIG. 18 illustrates the experimental results of the current density and overpotential measured for a Pd/NM catalyst and Pd/CB catalyst prepared in Experimental Example 8.

FIG. 19 illustrates the experimental results of the HER overpotential and mass-specific activity of noble metals according to the Pd weight of the Pd/NM catalyst.

FIG. 20 illustrates the HER Tafel slope and electrochemical resistance analysis graph of the Pd/NM catalyst.

FIG. 21 illustrates the electrochemical resistance analysis results of the Pd/NM catalyst.

FIG. 22 illustrates the constant current experimental results of the Pd/NM catalyst.

FIG. 23 illustrates the experimental results comparing the HER characteristics of Pd/NM catalysts recovered and prepared from ultrapure water and waste liquid environments, respectively, using linear sweep voltammetry (LSV).

### DETAILED DESCRIPTION OF THE INVENTION

The present invention provides a technology that can dramatically improve the recovery efficiency of palladium ions in water using MXene nanosheet ink.

In the present invention, MXene nanosheet ink refers to an aqueous solution in which MXene nanosheets are dispersed. By introducing the MXene nanosheet ink into an acidic solution including palladium ions, the palladium ions are adsorbed onto the MXene nanosheets, allowing the recovery of palladium ions.

In the present invention, the mechanism involved in the recovery of palladium ions may be largely divided into three stages (first Mechanism to third Mechanism).

The first mechanism involves the electrostatic attraction between protonated MXene nanosheets and palladium-chlorine complexes, causing the palladium-chlorine complexes to adsorb onto the surface of the protonated MXene nanosheets. The second mechanism is the reduction of the palladium ions into palladium nanoparticles through a redox reaction between the adsorbed palladium ions and the MXene nanosheets. The third mechanism involves the aggregation and precipitation of MXene nanosheets due to the electrostatic attraction between the anionic palladium nanoparticles and the protonated MXene nanosheets.

In the first mechanism, for electrostatic attraction to occur, the MXene nanosheets need to carry a positive charge, and the palladium ions need to exhibit anionic characteristics.

The surface of MXene nanosheets is provided with surface functional groups, such as —F, —O, and —OH, which are formed during the MXene nanosheet manufacturing process. These —F, —O, and —OH functional groups are hydrophilic functional groups that are easily protonated by hydrogen ions (H⁺) in an acidic solution environment. As the hydrophilic functional groups (—F, —O, —OH) on the surface of the MXene nanosheets become protonated, the surface of the MXene nanosheets acquires a positive charge. The method of manufacturing MXene nanosheets will be described below in detail.

Meanwhile, palladium ions (Pd²⁺) in water exist in a cationic state, but in a strongly acidic environment, they combine with Cl⁻, F⁻, NO₃²⁻, and similar anions in the acidic solution, acquiring anionic characteristics. For example, when Pd²⁺ combines with Cl⁻, it forms [PdCl₄]²⁻. In the present invention, a substance in which palladium ions combine with anions in an acidic solution is referred to as a ‘palladium-anion complex,’ and [PdCl₄]²⁻ is an example of a palladium-anion complex.

As described above, in an acidic solution, the surface of the MXene nanosheets becomes protonated and acquires a positive charge, while the palladium ions form palladium-anion complexes with anionic characteristics. As a result, the palladium-anion complexes are adsorbed onto the surface of the protonated MXene nanosheets. Through this mechanism, it becomes possible to adsorb palladium ions onto the MXene nanosheets.

In addition, in an acidic solution environment where palladium ions (Pd²⁺) coexist with other metal ions, such as Mg²⁺, Cu²⁺, Ni²⁺, Ca²⁺, K⁺, and Na⁺, only the palladium ions (Pd²⁺) combine with anions to form palladium-anion complexes, while the other metal ions do not combine with anions and remain in their cationic states. Due to this characteristic, electrostatic attraction occurs only between the palladium-anion complexes and the MXene nanosheets, enabling the selective adsorption of palladium ions through this mechanism.

From the above, it can be understood that the adsorption of palladium ions onto MXene nanosheets is determined by whether the surface of the MXene nanosheets carries a positive charge. The presence of a positive charge on the surface of MXene nanosheets may also be expressed by the zeta potential (ζ) of the MXene nanosheet surface. That is, when the zeta potential (ζ) of the MXene nanosheet surface is greater than 0, the palladium-anion complexes are adsorbed onto the surface of the MXene nanosheets due to electrostatic attraction. Conversely, when the zeta potential (ζ) is less than 0, no electrostatic attraction occurs between the MXene nanosheet surface and the palladium-anion complexes.

The zeta potential (ζ) of the MXene nanosheet surface is influenced by the pH and the surface functional groups of the MXene nanosheets. As described above, in an acidic solution environment, the surface functional groups of MXene nanosheets are protonated by hydrogen ions (H⁺). The pH and surface functional groups of the MXene nanosheets are interrelated, thereby determining the zeta potential (ζ) of the MXene nanosheet surface.

The higher the zeta potential (ζ) of the MXene nanosheet surface, the better the recovery rate and selectivity of the palladium-anion complexes. The zeta potential (ζ) of the MXene nanosheet surface is determined by the degree of protonation on the MXene nanosheet surface. The degree of protonation is directly related to the bonding extent between surface functional groups and hydrogen ions (H⁺). As the pH decreases, the concentration of hydrogen ions (H⁺) increases, which inevitably causes the zeta potential (ζ) of the MXene nanosheet surface to increase. That is, the best method to enhance the recovery rate and selectivity of palladium-anion complexes is to lower the pH as much as possible.

However, in practical environments for recovering palladium ions, such as semiconductor waste liquid including palladium ions, the pH ranges from 2 to 5. This indicates that a relatively high zeta potential (ζ) needs to be maintained even at higher pH levels, such as around pH levels of 4 to 5.

To maintain a high value of zeta potential (ζ) on the MXene nanosheet surface even at pH levels of 4 to 5, the surface functional group density of the MXene nanosheets needs to be optimized.

The zeta potential (ζ) increases as the MXene nanosheet surface becomes protonated through the bonding of surface functional groups with hydrogen ions (H⁺). Since the concentration of hydrogen ions (H⁺) increases as the pH decreases, the MXene nanosheet surface needs to be provided with sufficient surface functional groups to bond with hydrogen ions (H⁺).

However, when the density of surface functional groups is either too high or too low, it adversely affects the recovery rate and selectivity of palladium ions.

When the density of surface functional groups is too high, many unbound surface functional groups remain without bonding to hydrogen ions (H⁺). This indicates a low degree of protonation on the MXene nanosheet surface, and the low degree of protonation leads to a low level of zeta potential (ζ) on the MXene nanosheet surface. In this case, even if the pH is further lowered and the concentration of hydrogen ions (H⁺) increases, unbound surface functional groups may still remain. Due to these unbound residual surface functional groups, the increase in zeta potential (ζ) becomes inherently limited. Therefore, when the density of surface functional groups is too high, both the recovery rate and selectivity of palladium ions deteriorate.

Additionally, when the density of surface functional groups is too low, the surface functional groups of MXene nanosheets may theoretically bond with all available hydrogen ions (H⁺), even at higher pH levels where the hydrogen ion concentration is relatively low, reaching a protonation saturation state. By analogy, because the amount of surface functional groups is too small, even a small amount of hydrogen ions (H⁺) present may result in a state where all the surface functional groups on the MXene nanosheets becoming protonated. As such, since the amount of surface functional groups available to bond with hydrogen ions (H⁺) is limited, the maximum value of the zeta potential (ζ) is inevitably constrained. Furthermore, even if the pH is further lowered and the concentration of hydrogen ions (H⁺) increases, the zeta potential (ζ) remains nearly unchanged because the protonation of the surface functional groups is already in a saturated state. For example, when the highest zeta potential (ζ) is achieved at pH 2, even if the pH is lowered to 1, the zeta potential (ζ) remains at the same level as it was at pH 2. Therefore, when the density of surface functional groups is too low, the selectivity for palladium ions may not be poor, but the recovery rate of palladium ions inevitably decreases.

However, when the density of surface functional groups is too low, as referenced in the experimental examples described below, the insufficient surface functional group density hinders the smooth exfoliation of MXene nanosheets. This results in larger MXene nanosheet sizes, which degrade the adsorption characteristics for palladium ions. Theoretically, when the density of surface functional groups is too low, protonation saturation needs to occur at relatively high pH levels, such as pH 4 to 5, as described above. However, due to the significantly larger size of the MXene nanosheets, the adsorption characteristics for palladium ions deteriorate, and actual protonation saturation occurs at lower pH levels (pH 1 to 2).

In light of these points, the surface functional groups of MXene nanosheets need to be controlled to an optimal density. That is, an appropriate amount of surface functional groups need to be present on the surface of the MXene nanosheets. When an appropriate amount of surface functional groups is present, the maximum zeta potential (ζ) appears at a relatively higher pH. That is, protonation saturation occurs at a relatively higher pH, resulting in the maximum zeta potential (ζ). Even if the pH is further lowered, the corresponding maximum zeta potential (ζ) is maintained.

Additionally, when an appropriate amount of surface functional groups is present on the surface of the MXene nanosheets, the MXene nanosheets are formed at a small size. This avoids the issue of reduced adsorption performance caused by the significantly large MXene nanosheets, in cases where the surface functional group density is too low, as described above.

As such, when an appropriate amount of surface functional groups is present, the maximum zeta potential (ζ) is achieved even at relatively high pH levels, such as pH 4 to 5. This indicates that a high recovery rate and selectivity for palladium ions may be secured across a wide range of pH conditions.

Therefore, in the present invention, optimizing the surface functional group density of MXene nanosheets means ensuring that the zeta potential (ζ) of the MXene nanosheet surface reaches its maximum value or maintains a zeta potential above a certain value (e.g., 20 or higher) at relatively high pH levels, such as pH 4 to 5. Detailed measures to achieve these zeta potential characteristics may include the use of process conditions.

As an embodiment, the surface functional group density may be optimized by controlling the concentration of HF in the HF solution. The surface functional groups (—F, —O, —OH) of MXene nanosheets are generated during the etching process of the precursor of MXene nanosheets, MAX, using a strong acid, such as an HF solution. The higher the HF concentration in the HF solution, the higher the density of the surface functional groups. Therefore, the surface functional group density may be optimized by controlling the concentration of HF in the HF solution.

In addition to controlling the HF concentration in the HF solution, adjusting the process temperature during MAX etching may also be considered. Further, the optimization of surface functional group density may be achieved by controlling other process conditions as well.

The important point is to control the surface functional group density so that the zeta potential (ζ) of the MXene nanosheet surface reaches its maximum value or maintains a value of a certain value or more at relatively high pH levels (e.g., pH 4 to 5). In this case, the surface functional group density may be achieved by controlling various process conditions, such as the HF concentration in the HF solution and the process temperature during the etching of MAX.

With reference to the experimental examples described below, when palladium ion recovery was performed using MXene nanosheets with optimized surface functional group density, it was shown that palladium ions were recovered at 100%, while in an environment where other metal ions coexisted, the recovery rate of other metal ions was as low as 0.9% (Cu²⁺). The maximum adsorption capacity (qₘ) was shown as 1983.3 mg/g.

Comparing the maximum adsorption capacity of 1983.3 mg/g in the present invention with known technologies, it can be seen that it is more than 10 times superior to the maximum adsorption capacity of 184.56 mg/g reported in Non-Patent Document 1, which used MXene flakes. Furthermore, it is over twice as effective compared to the previously known best-performing polymer-based adsorbent (poly-Cys-g-PDA@GPUF, refer to Non-Patent Document 4) with a maximum adsorption capacity of 785 mg/g.

The above describes the first mechanism.

Through the first mechanism, it can be seen that palladium ions may be adsorbed onto MXene nanosheets, as well as, by optimizing the surface functional group density of the MXene nanosheets, a high recovery rate and selectivity for palladium ions may be achieved even at relatively high pH levels (pH 4 to 5).

Next, the second mechanism and third mechanism will be described.

The second mechanism involves the reduction of the adsorbed palladium ions into palladium nanoparticles through a redox reaction between the palladium ions and the MXene nanosheets. In the second mechanism, the palladium ions refer to Pd²⁺, which forms the palladium-anion complex. That is, in the second mechanism, Pd²⁺ is reduced to palladium nanoparticles (Pd NPs) through a redox reaction between Pd²⁺ and the MXene nanosheets.

The reduction of palladium ions (Pd²⁺) to palladium nanoparticles indicates that electrons (−) are donated to the palladium ions (Pd²⁺). The occurrence of electron donation implies that an oxidation reaction takes place on the MXene nanosheets. That is, through the redox reaction between Pd²⁺ and the MXene nanosheets, Pd²⁺ is reduced to palladium nanoparticles.

With reference to the experimental results described below, it was analyzed that the C—Ti—OH of the MXene nanosheets is oxidized to C—Ti—O and/or Ti—O by the adsorbed Pd²⁺, and Pd²⁺ is reduced to palladium nanoparticles by electrons (−) donated from the —OH groups on the surface of the MXene nanosheets. Additionally, due to this redox reaction, the peaks corresponding to Ti—C, Ti(II), and Ti(III) decrease, while the peak corresponding to Ti(IV) increases. Furthermore, it was analyzed that-F, one of the surface functional groups on the MXene nanosheets, polarizes adjacent oxygen atoms, increasing the overall polarity of the MXene nanosheets, thereby serving to facilitate the reduction reaction of Pd²⁺.

As such, the redox reaction between Pd²⁺ and the MXene nanosheets enables the reduction of Pd²⁺ to palladium nanoparticles.

The reduction of Pd²⁺ to palladium nanoparticles through the second mechanism is a critical mechanism both for the practical recovery of palladium and for the utilization of the recovered palladium as an electrochemical catalyst. In addition, the occurrence of the second mechanism enables the third mechanism. That is, when the reduction of Pd²⁺ to palladium nanoparticles through the second mechanism does not occur, the third mechanism will not take place.

As described above in the “Background Art,” nanoscale adsorbents have the issue of being difficult to recover due to their small size. In contrast, in the present invention, the recovery of palladium-adsorbed MXene nanosheets becomes significantly easier due to the second and third mechanisms.

The third mechanism, as described above, involves the aggregation and precipitation of MXene nanosheets due to the electrostatic attraction between the anionic palladium nanoparticles and the protonated MXene nanosheets.

Once the reduction of Pd²⁺ to palladium nanoparticles proceeds through the second mechanism, the third mechanism immediately follows, inducing the aggregation of the MXene nanosheets.

The palladium nanoparticles generated through the second mechanism inherently exhibit anionic characteristics. As a result, electrostatic attraction occurs between the anionic palladium nanoparticles and the protonated MXene nanosheets. Due to the electrostatic attraction between the palladium nanoparticles and the protonated MXene nanosheets, adjacent MXene nanosheets aggregate with each other, and the MXene nanosheet agglomerates precipitate within the solution.

As described above, through the second and third mechanisms, Pd²⁺ is reduced to form palladium nanoparticles. The electrostatic attraction between the anionic palladium nanoparticles and the protonated MXene nanosheets induces the aggregation and precipitation of the MXene nanosheets. Consequently, the palladium-adsorbed MXene nanosheets may be recovered very easily.

The reason that the aggregation and precipitation of MXene nanosheets may occur and be accelerated lies in the reduction of Pd²⁺ to palladium nanoparticles through the second mechanism, as described above. With reference to the experimental examples described below, it was confirmed that approximately 82.1% of the palladium content in the aggregated and precipitated material consists of palladium metal. In other words, this means that 82.1% of the adsorbed palladium ions are reduced to palladium nanoparticles.

In addition, the palladium-adsorbed MXene nanosheets may be recycled by desorbing the palladium from the MXene nanosheets through a regeneration process and then being manufactured back into MXene nanosheet ink, or the palladium-adsorbed MXene nanosheets themselves may be utilized as electrochemical catalysts, such as hydrogen evolution reaction (HER) catalysts.

In summary, the three mechanisms, i.e., first mechanism to third mechanism, involved in the recovery of palladium ions from water using MXene nanosheet ink according to the present invention have been described. Through these first to third mechanisms, the recovery rate and selectivity of palladium ions can be improved. Additionally, the palladium-adsorbed MXene nanosheets can be easily recovered, regenerated and utilized as electrochemical catalysts.

### MXene Nanosheet Ink and Method of Manufacturing the Same

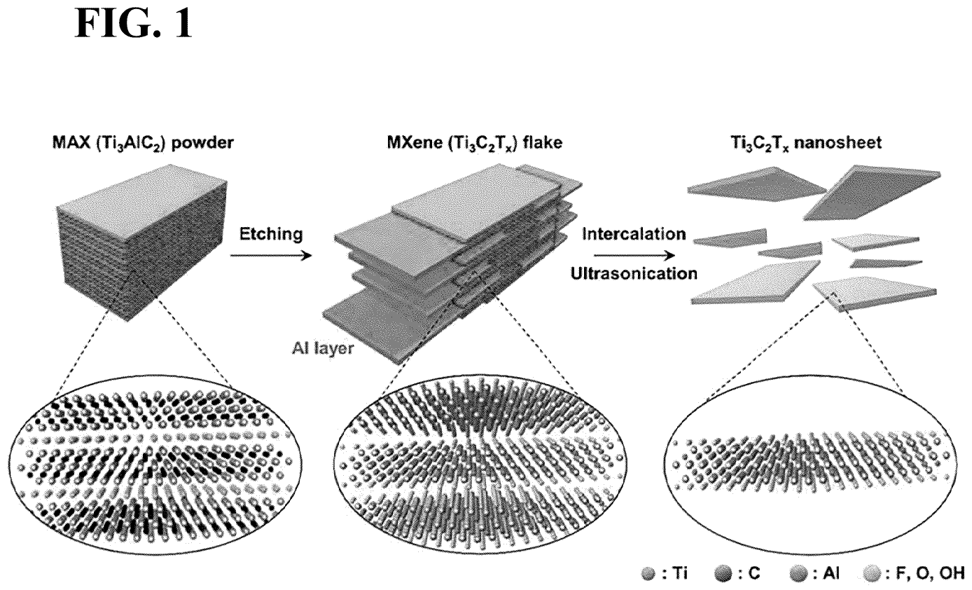

A method of manufacturing MXene nanosheet ink according to an embodiment of the present invention will be described as follows. FIG. 1 is a process schematic view for describing a method of manufacturing MXene nanosheets according to an embodiment of the present invention.

First, MAX, represented by Chemical Formula 1, is reacted with a strong acid solution to prepare MXene flakes, represented by Chemical Formula 2.

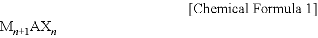

(where M is a transition metal, A is a group A element of the periodic table, X is carbon and/or nitrogen, and n is an integer from 1 to 4).

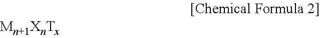

(where M is a transition metal, X is carbon and/or nitrogen, T is at least one selected from —O, —F, —OH, and —Cl, and n is an integer from 1 to 4).

As an embodiment, Mₙ₊₁AXₙ may be any one of Ti₃AlC₂, Ti₂CdC, Sc₂InC, Ti₂AlC, Ti₂GaC, Ti₂InC, Ti₂TlC, V₂AIC, V₂GaC, Cr₂GaC, Ti₂AlN, Ti₂GaN, Ti₂InN, V₂GaN, Cr₂GaN, Ti₂GeC, Ti₂SnC, Ti₂PbC, V₂GeC, Cr₂AlC, Cr₂GeC, V₂PC, V₂AsC, Ti₂SC, Zr₂InC, Zr₂TlC, Nb₂AlC, Nb₂GaC, Nb₂InC, Mo₂GaC, Zr₂InN, Zr₂TIN, Zr₂SnC, Zr₂PbC, Nb₂SnC, Nb₂PC, Nb₂AsC, Zr₂SC, Nb₂SC, Hf₂InC, Hf₂TlC, Ta₂AlC, Ta₂GaC, Hf₂SnC, Hf₂PbC, Hf₂SnN, Hf₂SC, V₃AlC₂, Ti₃SiC₂, Ti₃GeC₂, Ti₃SnC₂, Ta₃AlC₂, Ti₄AlN₃, V₄AlC₃, Ti₄GaC₃, Ti₄SiC₃, Ti₄GeC₃, Nb₄AlC₃, or Ta₄AlC₃, or a combination thereof.

The strong acid solution is a diluted solution of hydrofluoric acid (HF) or hydrochloric acid (HCl).

The HF concentration or HCl concentration in the strong acid solution is not particularly limited but may be set to 5 to 45%. Additionally, the reaction temperature for Mₙ₊₁AXₙ and the strong acid solution is not particularly limited but may be set to 15 to 55° C.

By reacting a MAX (Mₙ₊₁AXₙ) with a strong acid solution, the A component of Mₙ₊₁AXₙ is etched and removed, thereby forming surface functional groups such as —O, —F, —OH, and —Cl, and manufacturing MXene flakes of Chemical Formula 2. MXene flakes form a two-dimensional layered structure composed of multiple MXene nanosheets stacked together.

Next, the MXene flakes are introduced into an exfoliation solution to exfoliate the MXene flakes into MXene nanosheets. The exfoliation solution is a solution in which an intercalant is dissolved. The intercalant is inserted into the layered structure of the MXene flakes, causing the MXene flakes to exfoliate into nanosheet form. The substance of intercalant is not particularly limited, and in an example, tetramethylammonium hydroxide (TMAOH) may be used.

Once the exfoliation of MXene flakes into MXene nanosheets is complete, the residual intercalant is removed using ultrapure water or similar.

Then, by dispersing the MXene nanosheets in water, the preparation of MXene nanosheet ink is completed. The surface functional groups formed on the surface of MXene nanosheets are easily dispersed in water due to their hydrophilic characteristics. Ultrasonication may be applied to achieve uniform dispersion.

The MXene nanosheets dispersed in the MXene nanosheet ink achieve protonation saturation of their surface functional groups under acidic conditions with a pH of 4 to 5. This results in the MXene nanosheets having either the maximum zeta potential (ζ) or a zeta potential value of a certain value or more, in one embodiment, a zeta potential (ζ) of 20 or more.

To achieve these zeta potential characteristics, the surface functional group density of the MXene nanosheets may be adjusted. The surface functional group density of the MXene nanosheets may be adjusted by controlling the process conditions during the reaction between MAX and the strong acid solution. As an embodiment, the MXene nanosheets with the aforementioned zeta potential characteristics may be manufactured by controlling factors such as the concentration of the strong acid solution and the reaction temperature between MAX and the strong acid solution.

### Palladium Recovery Method Using MXene Nanosheet Ink

A method of recovering palladium using MXene nanosheet ink according to an embodiment of the present invention will be described as follows.

The MXene nanosheet ink prepared according to an embodiment of the present invention is introduced into an acidic solution including palladium ions (Pd²⁺). The acidic solution may also include ions such as Mg²⁺, Cu²⁺, Ni²⁺, Ca²⁺, K⁺, and Na⁺ in addition to palladium ions.

As the MXene nanosheet ink is introduced into the acidic solution, palladium ions are adsorbed onto the surface of the MXene nanosheets. The palladium-ion-adsorbed MXene nanosheets then aggregate with each other and precipitate. In this case, to ensure the dispersion stability of the MXene nanosheets, it is preferable for the concentration of MXene nanosheets in the MXene nanosheet ink to be 2 g/L or less.

The adsorption of palladium ions onto the surface of the MXene nanosheets, as well as the aggregation and precipitation of the MXene nanosheets, are explained by the previously described first to third mechanisms.

That is, through the first mechanism, the palladium-chlorine complexes are adsorbed onto the surface of the protonated MXene nanosheets due to the electrostatic attraction between the protonated MXene nanosheets and the palladium-chlorine complexes. Additionally, through the second mechanism, the adsorbed palladium ions are reduced to palladium nanoparticles by a redox reaction between the palladium ions and the MXene nanosheets. Further, finally, through the third mechanism, the MXene nanosheets aggregate and precipitate due to the electrostatic attraction between the anionic palladium nanoparticles and the protonated MXene nanosheets.

### Electrochemical Catalyst Using Recovered Palladium and Method of Manufacturing the Same

An electrochemical catalyst using the recovered palladium according to an embodiment of the present invention and a method of manufacturing the same are described as follows.

As described earlier in the “method of recovering palladium using MXene nanosheet Ink,” palladium ions are adsorbed onto the surface of MXene nanosheets by introducing MXene nanosheet ink into a solution including palladium ions. The reduction of palladium ions to palladium nanoparticles induces the aggregation and precipitation of the MXene nanosheets. The precipitate at this stage may be referred to as a palladium nanoparticle-immobilized MXene nanosheet aggregate.

The palladium nanoparticle-immobilized MXene nanosheet aggregate may be used in two ways. One approach is the desorption of palladium from MXene nanosheets through the regeneration process described above, which is then recycled into MXene nanosheet ink, and the other approach is the use as an electrochemical catalyst.

The electrochemical catalyst serves to facilitate electrochemical reactions when a power supply is applied, and may be used in a variety of electrochemical reactions. For example, the electrochemical catalysts are used in electrochemical hydrogen evolution reactions (HER).

In electrochemical reactions, electrochemical catalysts, which require the application of a power supply, typically have a structure where the catalytic material is coated onto a conductive electrode.

For such applications as an electrochemical catalyst, the electrochemical catalyst according to the present invention has a structure in which a palladium nanoparticle-immobilized MXene nanosheet aggregate is coated onto the surface of a conductive electrode.

Additionally, the following process may be used to manufacture the electrochemical catalyst according to the present invention.

First, a palladium nanoparticle-immobilized MXene nanosheet aggregate is mixed with an ion-conductive binder solution to prepare a catalyst ink. The ion-conductive binder solution is a solution in which an ion-conductive binder is dissolved. The ion-conductive binder physically binds the palladium nanoparticle-immobilized MXene nanosheet aggregates while also serving to mediate ion conduction between the palladium nanoparticles. The ion-conductive binders such as perfluorosulfonic acid-based ionomers may be used. Examples include commercially available products such as Nafion™ and Aquivion™.

Next, the catalyst ink is applied to the surface of the conductive electrode to form a coating, completing the manufacture of the electrochemical catalyst. The coating of the catalyst ink may be performed using methods such as drop casting, as an example. Additionally, the conductive electrode is not limited to its composition. For example, the conductive electrode may be composed of carbon-based conductive materials such as pyrolytic graphite, carbon foam, carbon paper, or glassy carbon, taking into account properties such as allowing current to flow to the catalyst during the electrochemical reaction, supplying electrons for electron exchange with molecules, corrosion resistance, and the redox reaction potential window.

In summary, the MXene nanosheet ink for palladium recovery and method of manufacturing the same, the method of recovering palladium using MXene nanosheet ink, and the electrochemical catalyst using the recovered palladium along with the method of manufacturing the same have been described according to an embodiment of the present invention. Hereinafter, a more detailed description of the present invention will be provided through experimental examples.

### Experimental Example 1: Manufacture of Mxene Nanosheet Ink

A mixture of TiC powder, Al powder, and Ti powder in a molar ratio of 2:1:1 was ball milled under a nitrogen atmosphere at 25° C. The resulting mixture was then heated at 1450° C. for 2 hours to synthesize MAX (Ti₃AlC₂) powder.

1 g of Ti₃AlC₂ powder was added to 20 mL of HF solutions with concentrations of 5%, 15%, 25%, 35%, and 45%, respectively. The mixtures were stirred at 25° C. for 24 hours to prepare Ti₃C₂Tₓ flakes. Subsequently, each Ti₃C₂Tₓ flake was exfoliated using TMAOH (tetramethylammonium hydroxide) to prepare Ti₃C₂Tₓ nanosheets. Specifically, Ti₃C₂Tₓ flakes were introduced to a solution prepared by dissolving 10 mL of TMAOH in 50 mL of ultrapure water. The mixture was stirred at 25° C. for 48 hours. Afterward, TMAOH was removed using ultrapure water, obtaining Ti₃C₂Tₓ nanosheets.

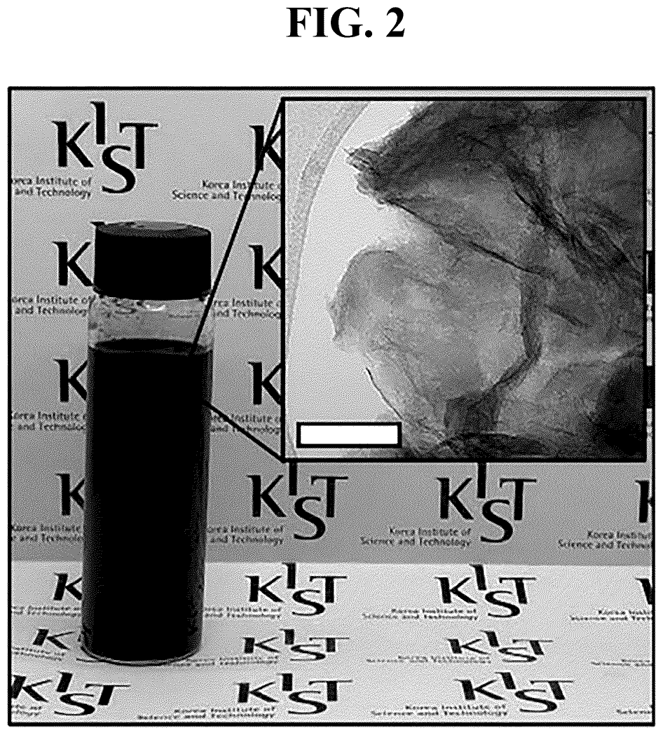

Finally, Ti₃C₂Tₓ nanosheets were introduced into ultrapure water and subjected to ultrasonication to manufacture Ti₃C₂Tₓ nanosheet ink, in which the Ti₃C₂Tₓ nanosheets were dispersed. FIG. 2 is an actual photograph of the Ti₃C₂Tₓ nanosheet ink prepared according to Experimental Example 1.

### Experimental Example 2: Properties of MXene Nanosheet

The specific surface area, hydrodynamic radius (H_{R}), and zeta potential (ζ) characteristics of the Ti₃C₂Tₓ nanosheets manufactured according to Experimental Example 1 were analyzed.

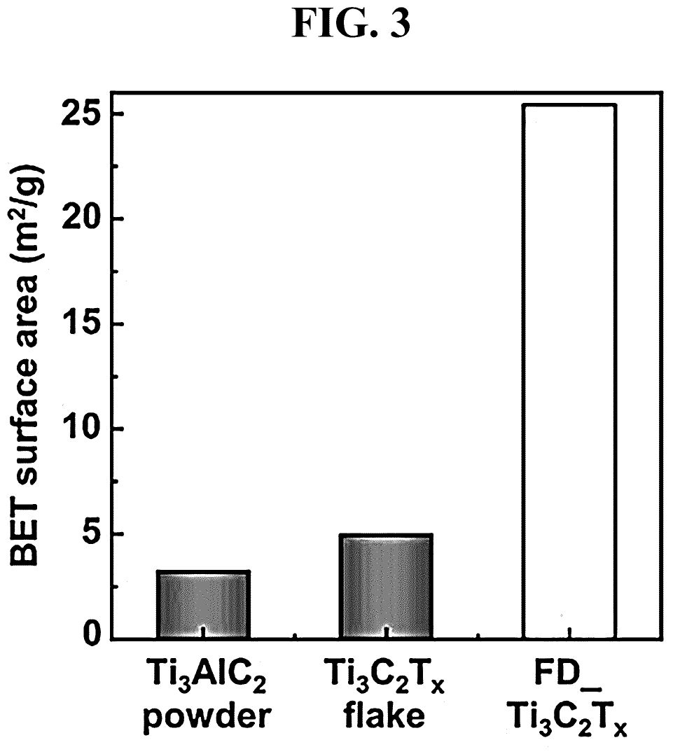

The specific surface areas of MAX (Ti₃AlC₂) powder, Ti₃C₂Tₓ flakes, and Ti₃C₂Tₓ nanosheets were measured (see FIG. 3). The specific surface area of Ti₃C₂Tₓ flakes (approximately 5 m²/g) showed a slight increase compared to Ti₃AlC₂ (approximately 3 m²/g). In contrast, the specific surface area of Ti₃C₂Tₓ nanosheets was measured at approximately 25 m²/g, representing about a fivefold increase compared to Ti₃C₂Tₓ flakes.

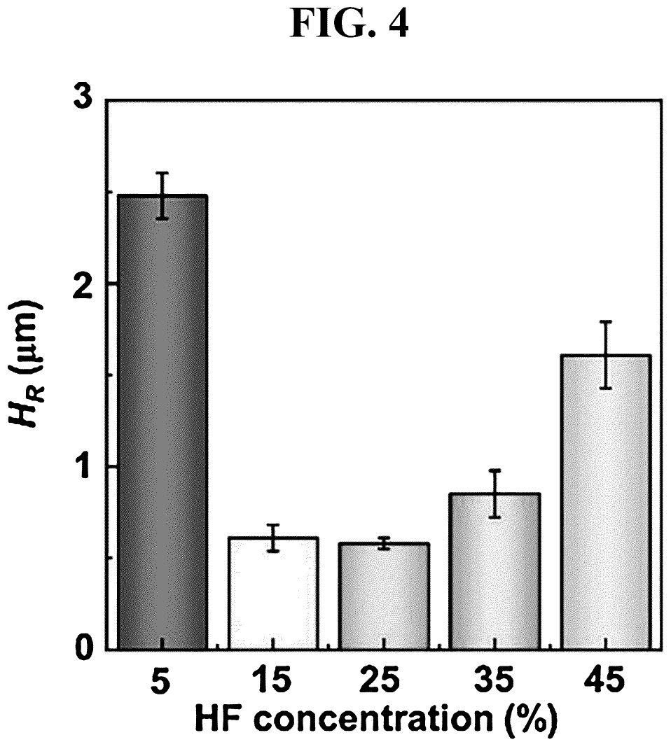

The hydrodynamic radius (H_{R}) of Ti₃C₂Tₓ nanosheets was measured based on the HF concentration (see FIG. 4). The results showed that the hydrodynamic radius (H_{R}) was largest when a 5% HF solution was applied. This result is attributed to the insufficient HF concentration, which led to a too low surface functional group density on the MXene nanosheets, preventing proper exfoliation of the MXene nanosheets. In contrast, when 15% and 25% HF solutions were applied, the hydrodynamic radius (H_{R}) of Ti₃C₂Tₓ nanosheets was found to be the smallest, similar to each other, indicating that the exfoliation of Ti₃C₂Tₓ nanosheets was carried out effectively.

Meanwhile, as the HF concentration increased beyond 25%, the hydrodynamic radius (H_{R}) of Ti₃C₂Tₓ nanosheets exhibited an exponential increase. This trend may be explained by the Ti₃C₂Tₓ lattice defects. As the HF concentration increases, the reaction with MAX becomes more vigorous, leading to the formation of defective vacancies in the Ti₃C₂Tₓ lattice. These defects induce the aggregation of carbon atoms, leading to the formation of an amorphous carbon structure, while also causing the oxidation of Ti atoms into TiO₂. As a result, the surface functional group density and specific surface area characteristics are degraded. It can be seen that when 35% and 45% HF solutions were applied, the lattice oxidation resulted in the binding energy peak at 458.9 eV corresponding to Ti(IV) with a high area ratio. In contrast, for Ti₃C₂Tₓ nanosheets with a 15% HF solution applied, the Ti(IV) peak exhibited a very small area, indicating that lattice oxidation was minimized.

The hydrodynamic radius (H_{R}) of Ti₃C₂Tₓ nanosheets also affects the palladium adsorption characteristics of Ti₃C₂Tₓ nanosheets.

The zeta potential (ζ) of Ti₃C₂Tₓ nanosheets was measured based on the HF concentration.

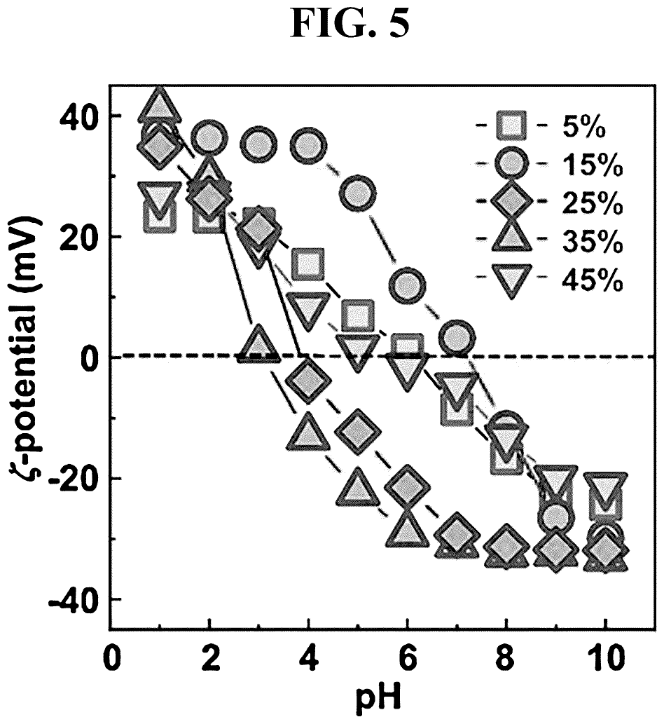

With reference to FIG. 5, in an alkaline environment, all Ti₃C₂Tₓ nanosheets exhibited a negative charge regardless of the HF concentration. As the pH decreased, the potential value tended to increase due to the increased protonation of surface functional groups. For Ti₃C₂Tₓ nanosheets with a 15% HF solution applied, the zeta potential (ζ) was the highest at approximately 35 mV at pH 4, and this value remained as the pH was lowered to 1.

This is attributed to differences in surface functional group density. Ti₃C₂Tₓ nanosheets with a 15% HF solution applied have a lower surface functional group density compared to Ti₃C₂ Tₓ nanosheets with 35% and 45% HF solutions applied. Therefore, for Ti₃C₂Tₓ nanosheets with 35% and 45% HF solutions applied, a higher concentration of hydrogen ions (H⁺) and consequently a lower pH are required to increase the zeta potential (9), compared to Ti₃C₂Tₓ nanosheets with a 15% HF solution applied. For example, when the pH decreases from 10 to 8, the zeta potential (C) of Ti₃C₂Tₓ nanosheets with a 15% HF solution applied shows a significant change. In contrast, the zeta potential (ζ) of Ti₃C₂Tₓ nanosheets with 35% and 45% HF solutions applied remains almost unchanged, indicating that the increased hydrogen ion (H⁺) concentration due to the pH reduction has little effect on the zeta potential (ζ) increase.

In conclusion, Ti₃C₂Tₓ nanosheets with a 15% HF solution applied maintained the maximum zeta potential (ζ) of approximately 35 mV in the pH range of 1 to 4. This indicates that the surface functional groups of the Ti₃C₂Tₓ nanosheets were saturated with hydrogen ions (H⁺) at pH 4. Meanwhile, Ti₃C₂Tₓ nanosheets with 5% and 45% HF solutions applied exhibited relatively lower zeta potential (ζ) compared to samples with other HF concentrations. This is likely due to incomplete exfoliation of the Ti₃C₂Tₓ nanosheets, lattice defects or the like.

### Experimental Example 3: Palladium Recovery Characteristics of MXene Nanosheet

Ti₃C₂Tₓ nanosheet ink was introduced into a palladium solution with a concentration of 500 mg/L at pH 1 to 3, and the mixture was stirred at 200 rpm. After stirring, the precipitate was filtered using a filtration membrane, and the Pd concentration was measured using ICP-OES. The concentration of Ti₃C₂Tₓ nanosheets in the Ti₃C₂Tₓ nanosheet ink was differently set to 0.1, 0.2, and 0.3 g/L.

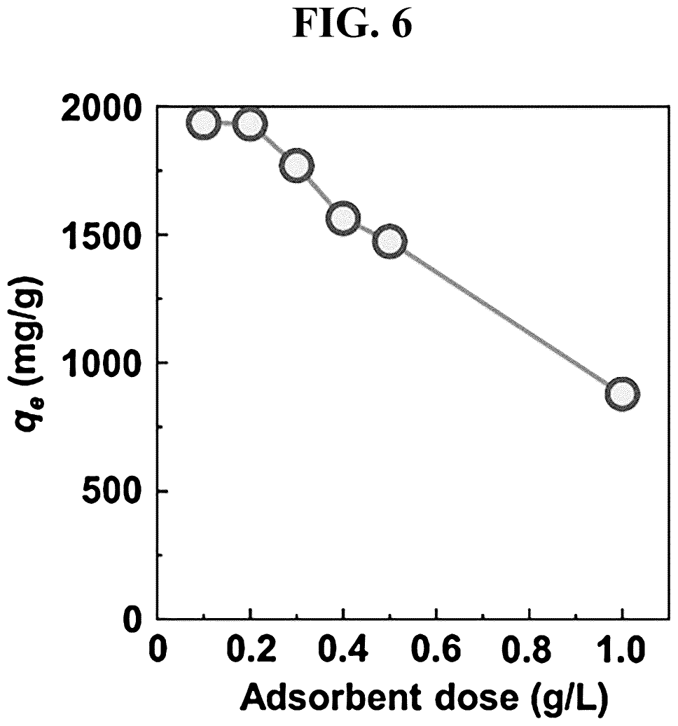

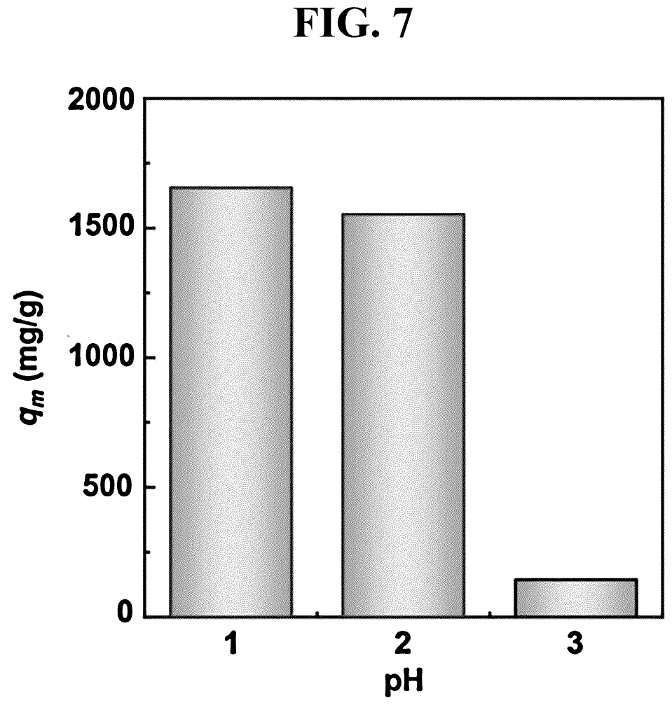

The adsorption capacity at equilibrium (ge) of Ti₃C₂Tₓ nanosheets was measured as 1937.3 mg/g at a Ti₃C₂Tₓ nanosheet concentration of 0.1 g/L and 1932.3 mg/g at a Ti₃C₂Tₓ nanosheet concentration of 0.2 g/L (see FIG. 6). When the concentration of Ti₃C₂Tₓ nanosheets was 0.3 g/L, the adsorption capacity (ge) decreased significantly. This is attributed to the saturation of adsorption sites. As the pH increased from 1 to 3, the adsorption capacity of Ti₃C₂Tₓ nanosheets for Pd²⁺ showed a decreasing trend (see FIG. 7).

For comparison, a palladium recovery experiment was conducted using carbon black (CB). Carbon black (CB) is considered one of the promising materials for Pd catalyst spacers due to its low cost, large specific surface area, and excellent electrical conductivity.

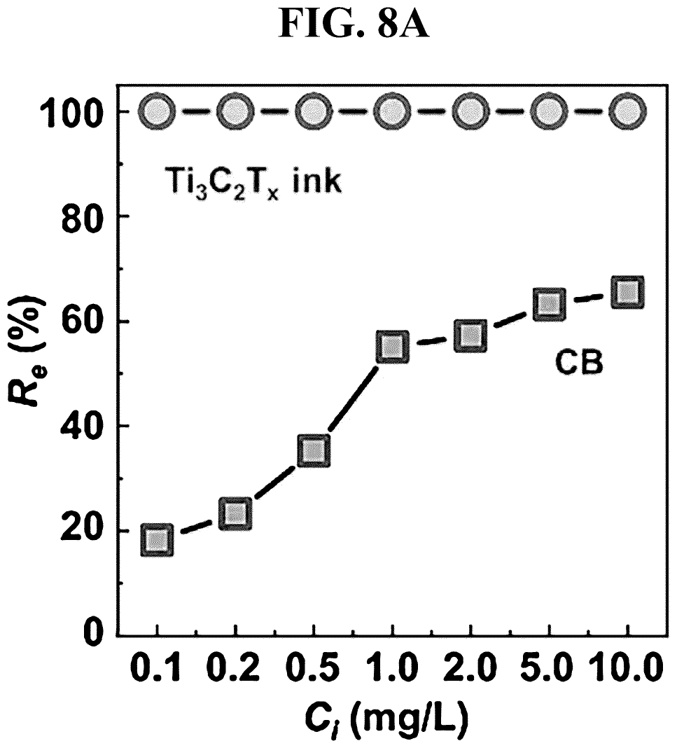

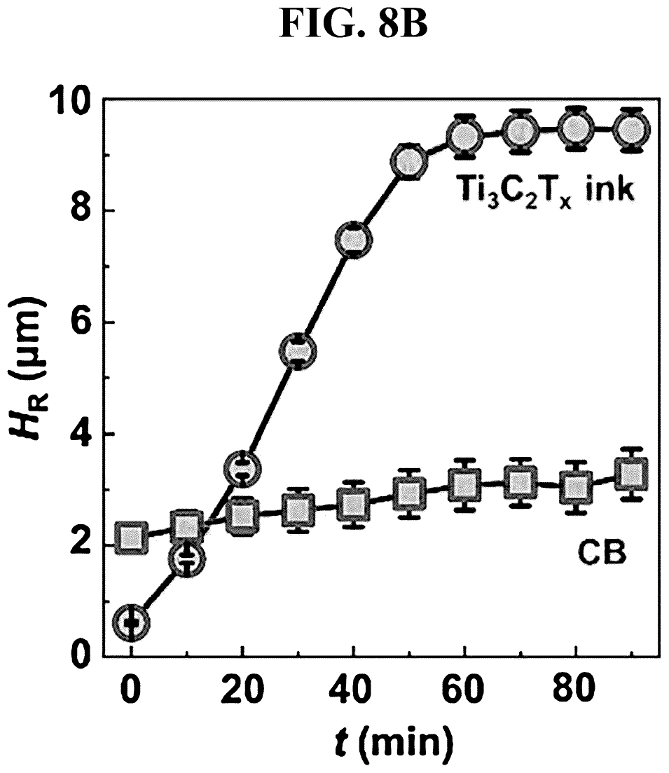

Ti₃C₂Tₓ nanosheets demonstrated a 100% palladium recovery rate (Re %) for initial palladium concentrations (Ci) ranging from 0.1 to 10 mg/L. In contrast, commercial carbon black (CB) showed a maximum recovery rate (Re %) of 65.6% for an initial palladium concentration (Ci) of 10 mg/L (see FIG. 8A). Additionally, for carbon black (CB), the recovery rate (Re %) tended to decrease as the initial palladium concentration (Ci) decreased. These results are attributed to differences in the electrostatic attraction acting on the palladium-anion complexes, which are supported by the zeta potential (ζ) of Ti₃C₂Tₓ nanosheets and carbon black (CB). This is because the zeta potential (ζ) of Ti₃C₂Tₓ nanosheets is approximately 36.8 mV, whereas the zeta potential (ζ) of carbon black (CB) is approximately 3.1 mV.

Additionally, an analysis of the precipitation behavior of Ti₃C₂Tₓ nanosheets and carbon black (CB) (see FIG. 8B) showed that the hydrodynamic radius (H_{R}) of carbon black (CB) did not significantly increase after Pd adsorption. This is due to its reliance on electrostatic attraction that are not effective for precipitation. In contrast, for Ti₃C₂Tₓ nanosheets, the hydrodynamic radius (H_{R}) increased rapidly and stabilized within 60 minutes, forming micrometer-sized precipitates (approximately 9.5 μm) that settled in the solution.

### Experimental Example 4: Maximum Adsorption Capacity of MXene Nanosheet

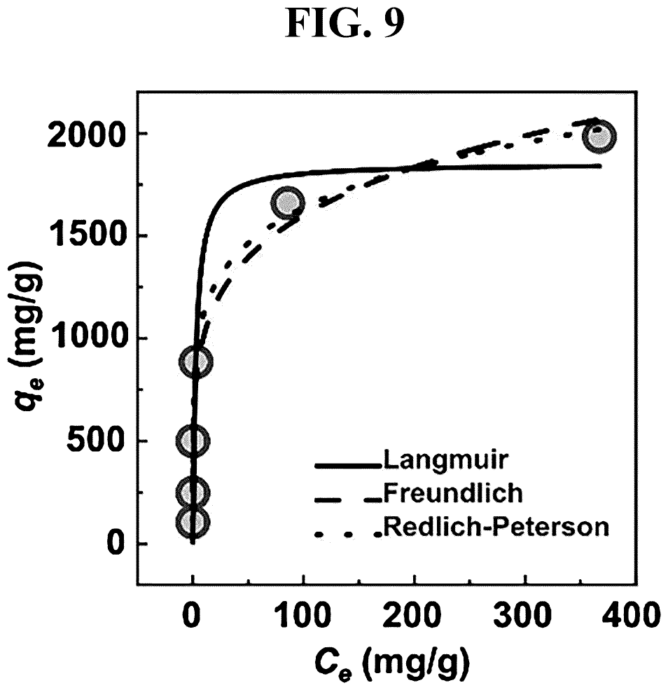

The isothermal adsorption curve of Ti₃C₂Tₓ nanosheet ink for Pd²⁺ was obtained, and it was confirmed that the data fit the Freundlich and Redlich-Peterson models (R²≥0.97) better than the Langmuir model (R²≥0.88) (see FIG. 9). These results indicate that Pd²⁺ is adsorbed onto Ti₃C₂Tₓ nanosheets through pseudo-multilayer adsorption behavior.

The maximum adsorption capacity (qₘ) of Ti₃C₂Tₓ nanosheets for Pd²⁺ was calculated to be 1983.3 mg/g. Additionally, the adsorption capacity of Ti₃C₂Tₓ nanosheets reached equilibrium within 60 minutes.

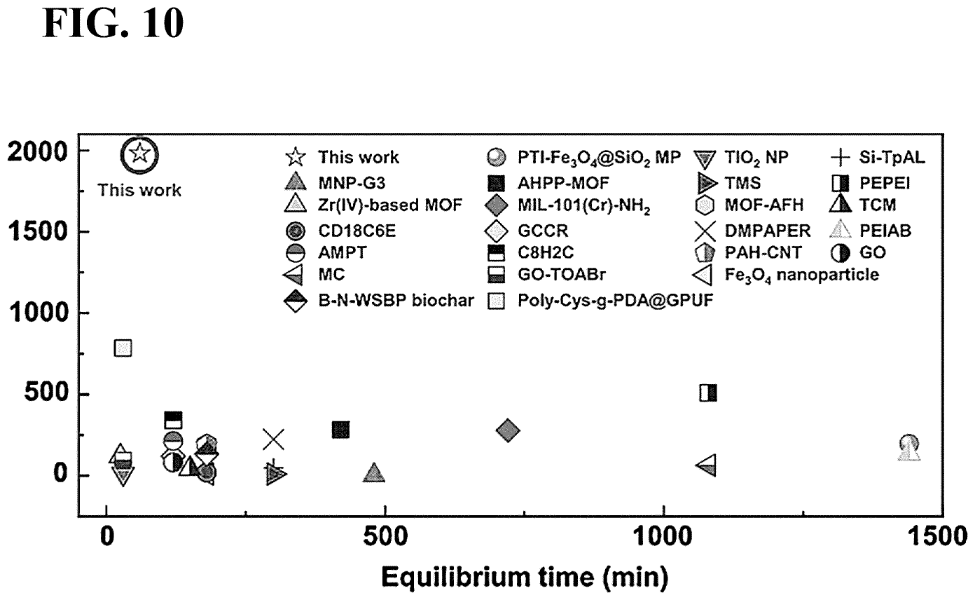

The maximum adsorption capacity (qₘ) of Ti₃C₂Tₓ nanosheets (1983.3 mg/g) and the adsorption equilibrium time (60 minutes or less) are significantly superior to the publicly-known Pd adsorbents. With reference to Table 1 below (maximum adsorption capacity (qₘ) and adsorption equilibrium time for each Pd adsorbent) and FIG. 10, the result is more than twice as superior compared to the polymer-based adsorbent (poly-Cys-g-PDA@GPUF, refer to Non-Patent Document 4), which is known for having the best palladium recovery properties with a maximum adsorption capacity of 785 mg/g.

The significantly superior maximum adsorption capacity (qₘ) and adsorption equilibrium time characteristics of Ti₃C₂Tₓ nanosheets according to the present invention are attributed to the fact that Ti₃C₂Tₓ nanosheets possess not only adsorption properties but also reductive properties. That is, the excellent maximum adsorption capacity (qₘ) and adsorption equilibrium time characteristics are exhibited due to the ability of adsorbing palladium-anion complexes through electrostatic attraction and reducing Pd²⁺ to Pd nanoparticles through a redox reaction between Pd²⁺ and the Ti₃C₂Tₓ nanosheets. This is a clear distinction from conventional Pd adsorbents, which rely solely on their adsorption properties.

TABLE 1

| | | | Equilibrium | |
|---|---|---|---|---|
| Adsorbent | | q [symbol] | time | |
| type | Adsorbent | (mg g⁻¹) | (min) | Ref. |
| Metal-based | P [symbol] -F [symbol] O [symbol] S [symbol] O [symbol] M [symbol] | 196 | 1440 | [1] |
| Adsorbents | TiO₂NP [symbol] | 12 | 30 | [2] |
| MOF [symbol] -based | Si-TpAL [symbol] | 48 | 300 | [3] |
| Adsorbents | MNP-O3 [symbol] | 3 | 480 | [4] |
| | AHPP-MOF [symbol] | 284 | 420 | [5] |
| | Fe [symbol] O [symbol] nanoparticle | 11 | 180 | [6] |
| | TMS [symbol] | 10 | [symbol] 00 | [7] |
| | [symbol] (IV)-based MOF | 120 | 25 | [8] |
| | MIL-101(Cr)-NH [symbol] | 278 | 720 | [9] |
| | MOF-AFH [symbol] | 193 | 180 | [10] |
| | Ti [symbol] T [symbol] nanosheet ink | 1983.3 | 60 | This |
| | | | | work |
| Polymer-based | PEPEI [symbol] | 509 | 1080 | [11] |
| adsorbents | CD18 [symbol] 6E [symbol] | 1 [symbol] | 180 | [12] |
| Biomass-based | poly-Cys-g-PDA@ [symbol] PUF [symbol] | 785 | 30 | [13] |
| adsorbents | GCCR [symbol] | 120 | 120 | [14] |
| | DMPAPER [symbol] | 224 | 300 | [15] |
| | AMPT [symbol] | 2 [symbol] 4 | 120 | [16] |
| | C8H2C [symbol] | 340 | 120 | [17] |
| | PEIAB [symbol] | 136 | 1440 | [18] |
| | TCM [symbol] | 42 | 150 | [19] |
| Carbon-based | PAH-CNT [symbol] | 187 | 1 [symbol] 0 | [20] |
| adsorbents | [symbol] O [symbol] | 81 | 120 | [21] |
| | MC [symbol] | 64 | 1080 | [22] |
| | [symbol] O-TOABr [symbol] | 93 | 30 | [23] |
| | B-N-WSBP biochar [symbol] | 134 | 180 | [24] |

[symbol]

indicates data missing or illegible when filed

### REFERENCE

1. Fan, R., Min, H., Hong, X., Yi, Q., Liu, W., Zhang, Q. & Luo, Z. Plant tannin immobilized Fe3O4@SiO2 microspheres: A novel and green magnetic bio-sorbent with superior adsorption capacities for gold and palladium. J. Hazard. Mater. 364, 780-790 (2019).
2. Qing, Y., Hang, Y., Wanjaul, R., Jiang, Z. & Hu, B. Adsorption behavior of noble metal ions (Au, Ag, Pd) on nanometer-size titanium dioxide with ICP-AES. Anal. Sci. 19, 1417-1420 (2003).
3. Wu, H., Kim, S.-Y., Ito, T., Miwa, M. & Matsuyama, S. One-pot synthesis of silica-gel-based adsorbent with Schiff base group for the recovery of palladium ions from simulated high-level liquid waste. Nucl. Eng. Technol. 54, 3641-3649 (2022).
4. Yen, C.-H., Lien, H.-L., Chung, J.-S. & Yeh, H.-D. Adsorption of precious metals in water by dendrimer modifiedmagnetic nanoparticles. J. Hazard. Mater. 322, 215-222 (2017).
5. Tang, J., Zhao, J., Wang, S., Zhang, L., Zhao, M., Huang, Z. & Hu, Y. Pre-modification strategy to prepare a novel Zr-based MOF for selective adsorption of Palladium (II) from solution. Chem. Eng. J. 407, 127223 (2021).
6. Uheida, A., Iglesias, M., Font^{□Δ}s, C. & Zhang, Y.; Muhammed, M.
Adsorption behavior of platinum group metals (Pd, Pt, Rh) on nonylthiourea-coated Fe₃O₄ nanoparticles. Sep. Sci. Technol. 41, 909-923 (2006).
7. Kang, T.; Park, Y.; Yi, J. Highly selective adsorption of Pt2+ and Pd2+ using thiol-functionalized mesoporous silica. Ind. Eng. Chem. Res. 43, 1478-1484 (2004).
8. Lin, S., Reddy, D. H. K., Bediako, J. K., Song, M.-H., Wei, W., Kim, J.-A. & Yun, Y.-S. Effective adsorption of Pd (II), Pt (IV) and Au (III) by Zr (IV)-based metal-organic frameworks from strongly acidic solutions. J. Mater. Chem. A 5, 13557 (2017).
9. Lim, C.-R., Lin, S. & Yun, Y.-S. Highly efficient and acid-resistant metal-organic frameworks of MIL-101 (Cr)—NH2 for Pd (II) and Pt (IV) recovery from acidic solutions: Adsorption experiments, spectroscopic analyses, and theoretical computations. J. Hazard. Mater. 387, 121689 (2020).
10. Tang, J., Chen, Y., Wang, S., Kong, D. & Zhang, L. Highly efficient metal-organic frameworks adsorbent for Pd(II) and Au(III) recovery from solutions: Experiment and mechanism. Environ. Res. 210, 112870 (2022).
11. Bratskaya, S., Privar, Y., Ustinov, A., Azarova, Y. & Pestov, A. Recovery of Au (III), Pt (IV), and Pd (II) using pyridylethyl-containing polymers: Chitosan derivatives vs synthetic polymers. Ind. Eng. Chem. Res. 55, 10377-10385 (2016).
12. Grad, O., Ciopec, M., Negrea, A., Duteanu, N., Vlase, G., Negrea, P., Dumitrescu, C., Vlase, T. & Vod-, R. Precious metals recovery from aqueous solutions using a new adsorbent material. Sci. Rep. 11, 2016 (2011).
13. Xue, D., Li, T., Liu, Y., Yang, Y., Zhang, Y., Cui, J. & Guo, D. Selective adsorption and recovery of precious metal ions from water and metallurgical slag by polymer brush graphene-polyurethane composite. React. Funct. Polym. 136, 138-152 (2019).
14. Adhikari, C. R., Parajuli, D., Kawakita, H., Inoue, K., Ohto, K. & Harada, H. Dimethylaminemodified waste paper for the recovery of precious metals. Environ. Sci. Technol. 42, 5486-5491 (2008).
15. Ramesh, A., Hasegawa, H., Sugimoto, W., Maki, T. & Udea, K. Adsorption of gold(III), platinum(IV) and palladium(II) onto glycine modified crosslinked chitosan resin. Bioresour. Technol. 99, 3801-3809 (2008).
16. Adhikari, C. R., Parajuli, D., Kawakita, H., Inoue, K., Ohto, K. & Harada, H. Dimethylaminemodified waste paper for the recovery of precious metals. Environ. Sci. Technol. 42, 5486-5491 (2008).
17. Gurung, M., Adhikari, B. B., Morisado, S., Kawakita, H., Ohto, K., Inoue, K. & Alam, S. Naminoguanidine modified persimmon tannin: A new sustainable material for selective adsorption, preconcentration and recovery of precious metals from acidic chloride solution. Bioresour. Technol. 129, 108-117 (2013).
18. Mincke, S., Asere, T. G., Verheye, I., Folens, K., Bussche, F. V., Lapeire, L., Verbeken, K., Voort, P. V. D., Tessema, D. A., Fufa, F., Laing, G. D. & Stevens, C. V. Functionalized chitosan adsorbents allow recovery of palladium and platinum from acidic aqueous solutions. Green Chem. 21, 2295 (2019).
19. Wang, S., Vincent, T., Roux, J.-C., Faur, C. & Guibal, E. Pd(II) and Pt(IV) sorption using alginate and algal-based beads. Chem. Eng. J. 313, 567-579 (2017).
20. Zhou, L., Liu, J. & Liu, Z. Adsorption of platinum (IV) and palladium (II) from aqueous solution by thiourea-modified chitosan microspheres. J. Hazard. Mater. 172, 439-446 (2009).
21. Liu, L., Liu, S., Zhang, Q., Li, C., Bao, C., Liu, X. & Xiao, P. Adsorption of Au (III), Pd (II), and Pt (IV) from aqueous solution onto graphene oxide. J. Chem. Eng. Data 58, 209-216 (2013).
22. Zalupski, P. R., McDowell, R. & Dutech, G. The adsorption of gold, palladium, and platinum from acidic chloride solutions on mesoporous carbons. Solvent Extr. Ion Exch. 32, 737-748 (2014).
23. Sharma, S. & Rajesh, N. Synergistic influence of graphene oxide and tetraoctylammonium bromide (frozen ionic liquid) for the enhanced adsorption and recovery of palladium from an industrial catalyst. J. Environ. Chem. Eng. 4, 4287-4298 (2016).
24. Wang, Z., Xu, X., Ma, S., Wang, H., Zhao, H., Wang, Y., Tong, S., Su, Z., Wang, W. & Bai, J. The superior adsorption capacity of boron-nitrogen co-doping walnut shell biochar powder for Au (III), Pt (IV), and Pd (II). J. Environ. Chem. Eng. 9, 106288 (2021).

### Experimental Example 5: Selectivity of MXene Nanosheet for Palladium Ions

In actual waste liquid including palladium, various metal ions (Mg²⁺, Cu²⁺, Ni²⁺, Ca²⁺, K⁺, Na⁺) are present, making the selective recovery of palladium critically important.

A solution was prepared in which each of Mg²⁺, Cu²⁺, Ni²⁺, Ca²⁺, K⁺, and Na⁺ had an initial concentration (Ci) of 100 mg/L, and Pd²⁺ had an initial concentration (Ci) of 1 mg/L. Ti₃C₂Tₓ nanosheet ink (0.2 g/L) was then introduced into the solution. The pH of the solution was not adjusted and was measured to be 3.9. In addition, for comparison, Ti₃C₂Tₓ nanosheets with 5%, 15%, 25%, 35%, and 45% HF solutions applied were each prepared as inks and introduced into the solution.

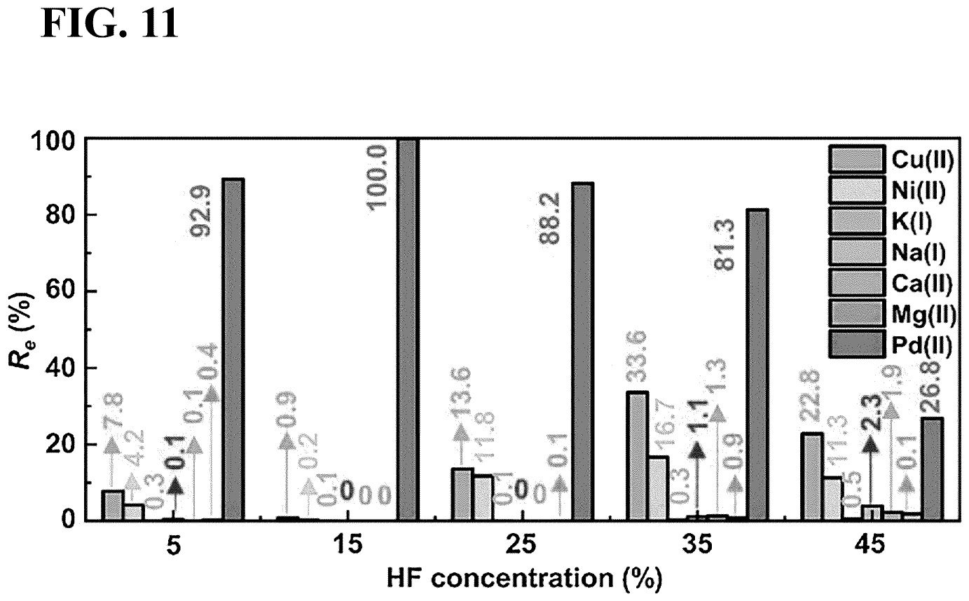

With reference to FIG. 11, when Ti₃C₂Tₓ nanosheet ink with a 15% HF solution applied was introduced, it exhibited a palladium recovery rate of approximately 100%. Simultaneously, the recovery rates of other metal ions were analyzed to be less than 1.0%. This result demonstrates the exceptional recovery rate and selectivity for palladium ions.

When Ti₃C₂Tₓ nanosheet ink with a 5% HF solution applied was introduced, it exhibited high recovery (89.9%) and selectivity. However, the recovery rate and selectivity were slightly lower compared to those achieved with the ink with a 15% HF solution applied. This result is attributed to the fact that the zeta potential (ζ) of Ti₃C₂Tₓ nanosheets with a 15% HF solution applied is 35.0 mV, whereas that of Ti₃C₂Tₓ nanosheets with a 5% HF solution applied is only 22.3 mV. As described above, this is due to the lower surface functional group density and incomplete exfoliation of Ti₃C₂Tₓ nanosheets.

When HF solutions with a concentration of 25% or higher were applied, the surface of the Ti₃C₂Tₓ nanosheets exhibited a negative charge or a low zeta potential (ζ) even under pH 3.9 conditions (35% HF solution: −13.1 mV, 25% HF solution: −3.8 mV, 45% HF solution: 8.4 mV). These zeta potential (ζ) characteristics result in low affinity for palladium-anion complexes and electrostatic attraction with coexisting metal ions. Therefore, the selectivity for palladium ions inevitably decreases. Furthermore, as previously described, lattice defects are present when 25%, 35%, and 45% HF solutions are applied.

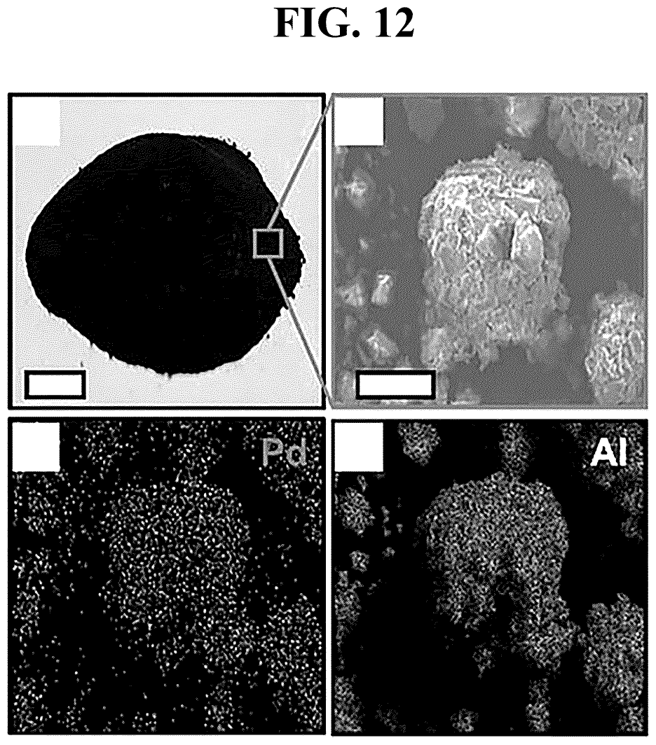

As an additional experiment, a palladium ion recovery experiment of Ti₃C₂Tₓ nanosheets was conducted on an actually used spent Pd catalyst. Pd catalysts are typically configured to be in the form of being coated on an alumina (γ-Al₂O₃) support structure (see FIG. 12). The total organic carbon (TOC) concentration in the waste liquid including the actually used spent Pd catalyst was 1.42 mg/L, the Pd²⁺ concentration was 10.80 mg/L, and the Al³⁺ concentration was 4.18 mg/L.

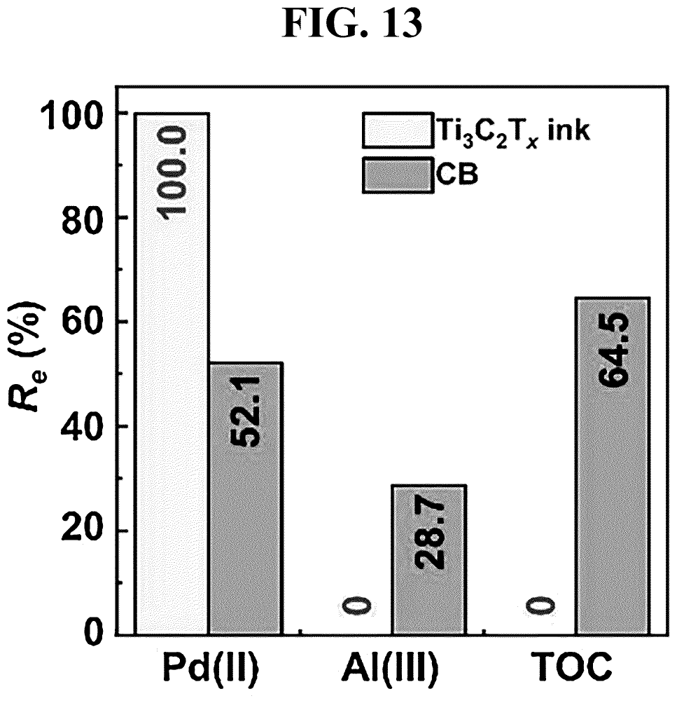

Ti₃C₂Tₓ nanosheet ink was introduced into the waste liquid including the actually used spent Pd catalyst, resulting in the recovery of Pd²⁺ at 100% without the recovery of TOC or Al³⁺ (see FIG. 13). For comparison, carbon black (CB) was introduced as a Pd²⁺ adsorbent into the waste liquid including the actually used spent Pd catalyst. The results showed a low Pd²⁺ recovery rate, along with a high recovery rate of TOC and Al³⁺. These experimental results demonstrate that the Ti₃C₂Tₓ nanosheet ink of the present invention is the optimal Pd²⁺ adsorbent for recovering palladium from actually used spent Pd catalysts because of exceptional recovery rate and selectivity, while being cost-effective to manufacture.

### Experimental Example 6: Palladium Recovery Mechanism of MXene Nanosheet

As described earlier, the first to third mechanisms play a role in the palladium recovery using MXene nanosheets in the present invention. These first to third mechanisms are supported by the experimental results and analyses of Experimental Example 6.

To elucidate the palladium recovery mechanism of Ti₃C₂Tₓ nanosheet ink under acidic conditions, various analyses were conducted on the palladium-adsorbed Ti₃C₂Tₓ nanosheets (Pd@Ti₃C₂Tₓ).

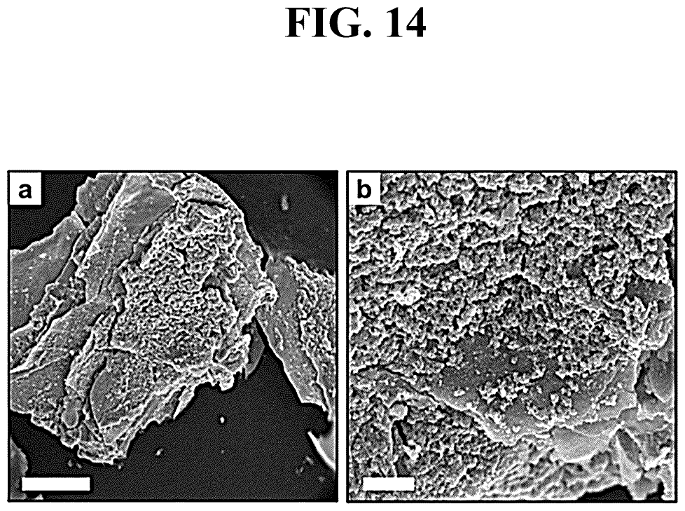

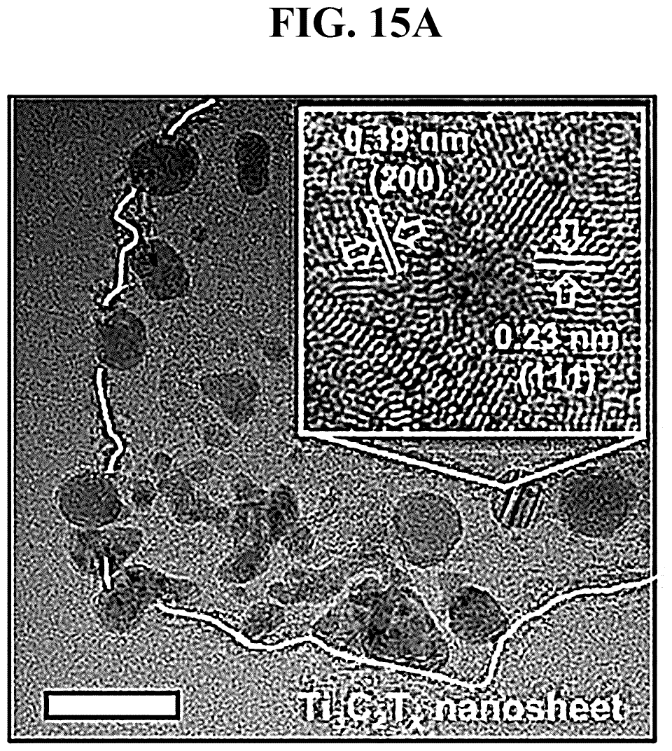

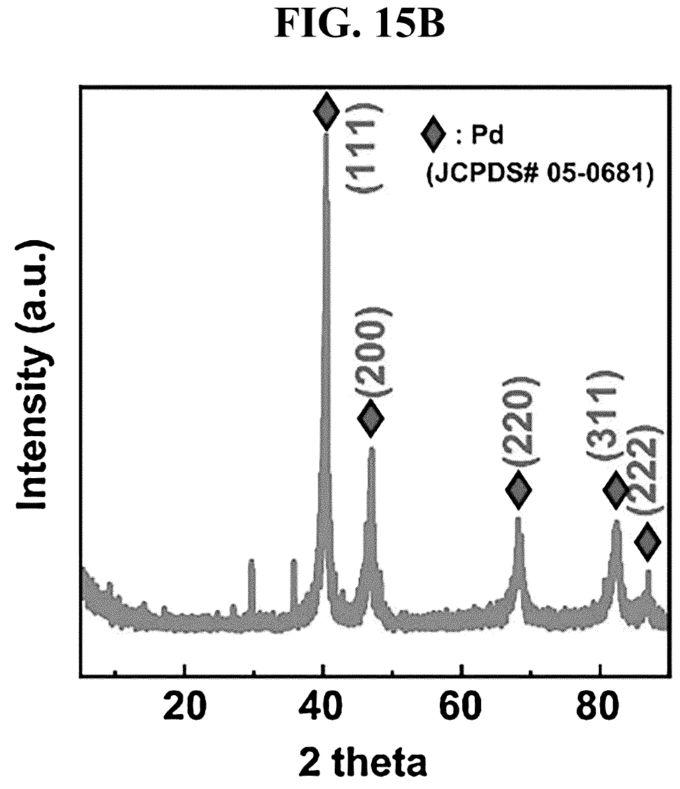

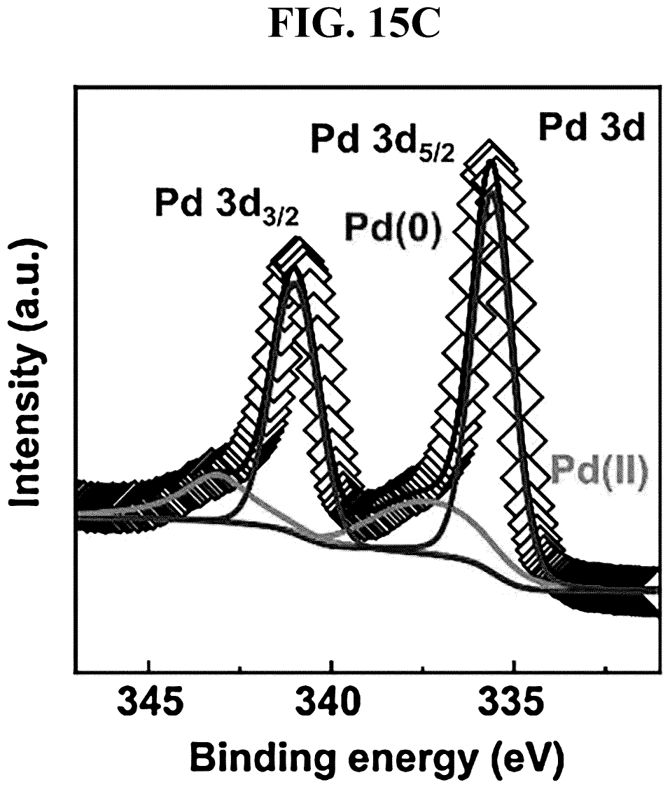

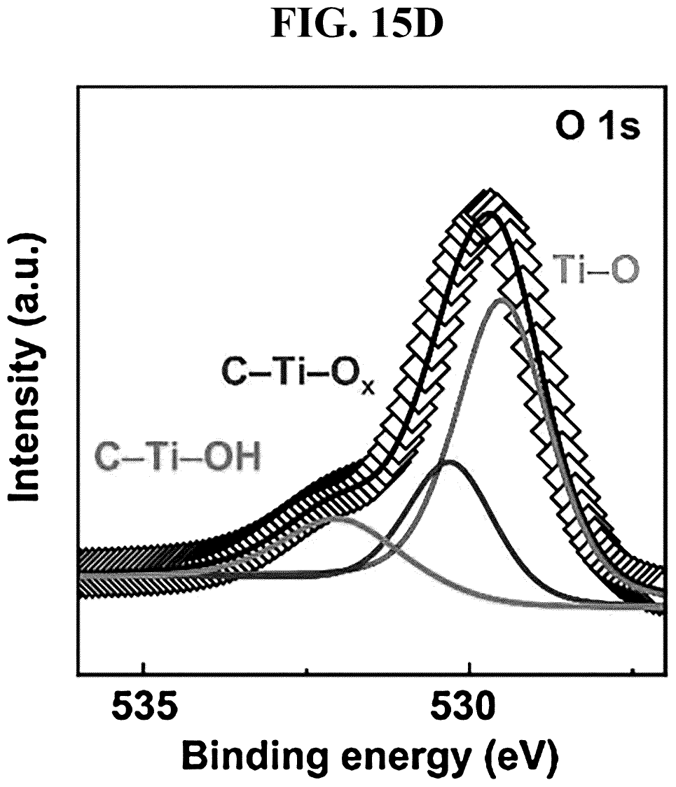

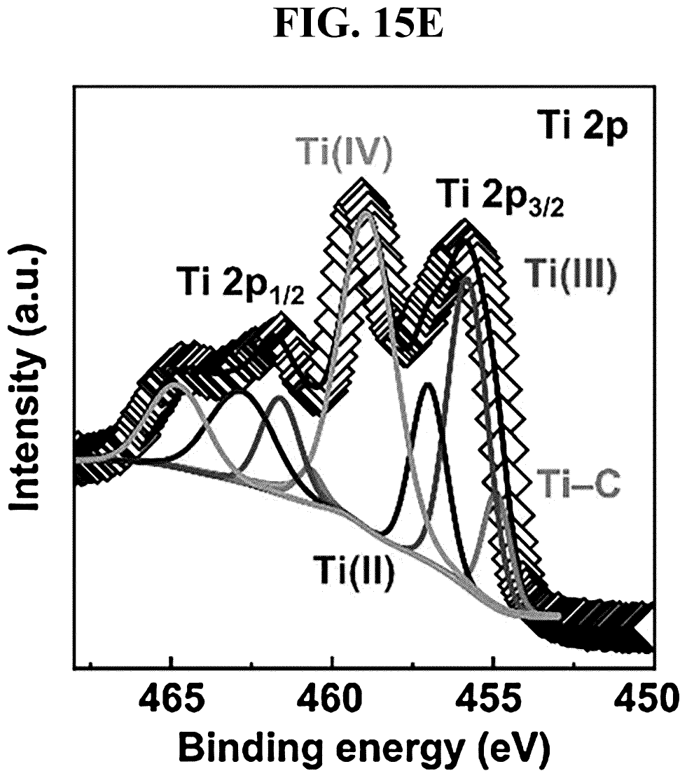

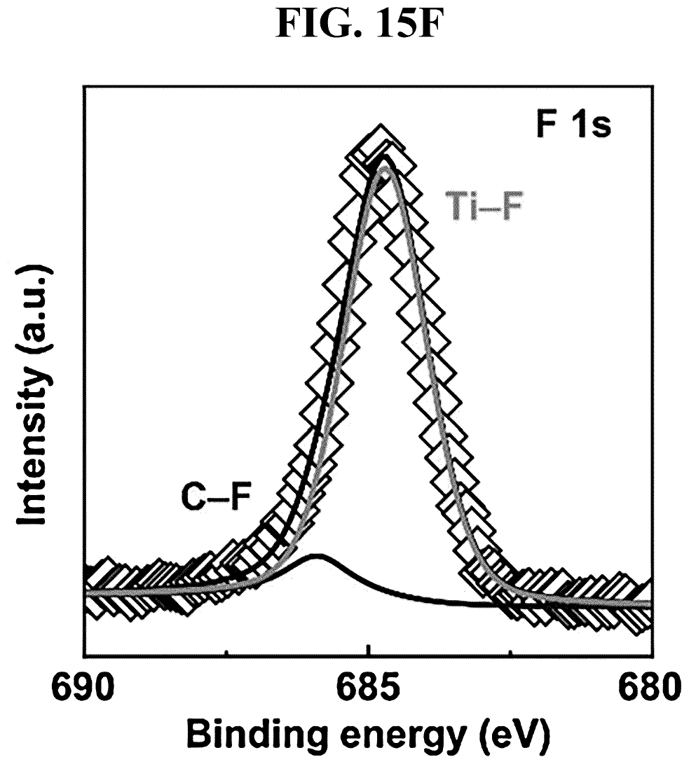

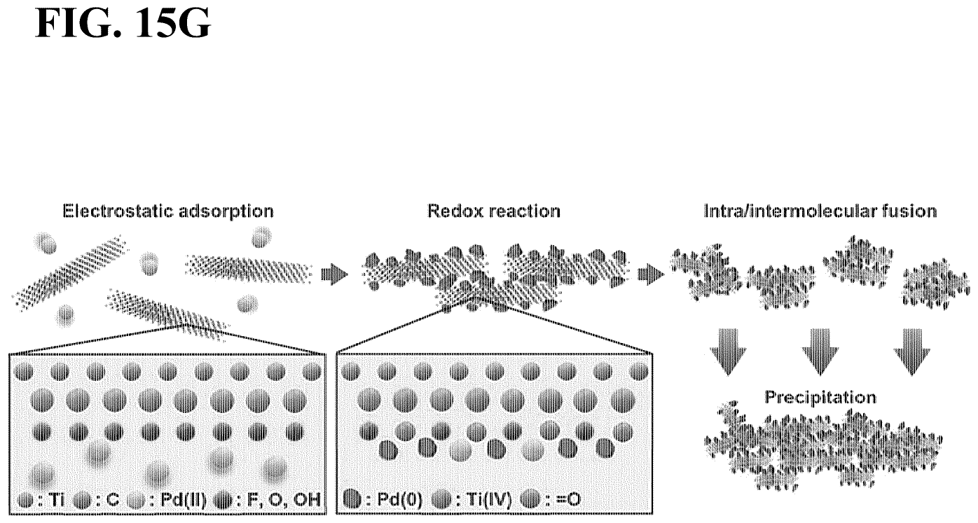

FIG. 14 illustrates the FESEM image of Pd@Ti₃C₂Tₓ, revealing that a crystalline structure is uniformly covering the surface of the Ti₃C₂Tₓ nanosheets. Additionally, with reference to the HRTEM image of Pd@Ti₃C₂Tₓ in FIG. 15A, it can be seen that Pd²⁺ adsorbed on the surface of Ti₃C₂Tₓ nanosheets has been reduced to palladium nanoparticles (Pd Nps). This result is consistent with the XRD analysis results (see FIG. 15B). Furthermore, the HRXPS spectrum of Pd@Ti₃C₂Tₓ for Pd 3d shows that the Pd@Ti₃C₂Tₓ precipitate exhibits two separate Pd 3d peaks corresponding to the Pd²⁺ and reduced Pd metal states with a high fraction of 82.1% (see FIG. 15C and Table 2). This indicates that most of the Pd²⁺ adsorbed onto the Ti₃C₂Tₓ nanosheets through electrostatic attraction is converted into crystalline palladium nanoparticles. Additionally, these results contrast with those of carbon black (CB), which only exhibited peaks corresponding to Pd²⁺.

TABLE 2
<Binding energy and peak area for Pd 3d in the XPS
spectrum of the Pd@Ti₃C₂Tₓ precipitate>

| | | Fitted | |
|---|---|---|---|
| | Binding | peak | |
| | energy | area | |
| Peak | (eV) | (%) | Assignment |
| Pd 3d | 335.6/341.0 | 82.1 | Pd(0) |
| | 337.3/343.1 | 17.9 | Pd(III) |

After Pd recovery, the HRXPS spectrum analysis of Ti₃C₂Tₓ nanosheets for O 1s indicates that the surface functional group —OH donates electrons to reduce Pd²⁺ adsorbed on the Ti₃C₂Tₓ nanosheets (see FIG. 15D). Additionally, C—Ti—OH is oxidized to C—Ti—O and/or Ti—O by Pd²⁺. After Pd recovery, it can be seen that the HRXPS Ti 2p spectrum of Ti₃C₂Tₓ nanosheets shows a significant reduction in peaks related to Ti—C, Ti(II), and Ti(III), while the peak corresponding to Ti(IV) increases due to redox reactions (see FIG. 15E).

Meanwhile, the HRXPS spectrum of Ti₃C₂Tₓ nanosheets for F 1s indicates that the surface functional group —F primarily exists in the form of Ti—F (see FIG. 15F). Due to its very high electronegativity, —F may not directly contribute to Pd recovery. However, fluorine (F) atoms adjacent to oxygen atoms polarize the oxygen atoms, increasing the overall polarity of the Ti₃C₂Tₓ nanosheets. This induces the active reduction of Pd²⁺. As a result, after Pd recovery, the peaks corresponding to Ti—F and C—F at 684.3 eV and 685.7 eV, respectively, shifted to higher binding energies of 684.7 eV (+0.4 eV) and 685.9 eV (+0.2 eV). From the above, it can be inferred that the electron transfer from fluorine to oxygen induces an active redox reaction between Pd²⁺ and Ti₃C₂Tₓ nanosheets.

In summary, under acidic conditions, the palladium-anion complex ([PdCl₄]²⁻) is adsorbed onto positively charged Ti₃C₂Tₓ nanosheets through electrostatic attraction (see the left schematic view in FIG. 15G). The Pd²⁺ adsorbed on Ti₃C₂Tₓ nanosheets is easily reduced to palladium nanoparticles (Pd NPs) because the reduction potential of Pd²⁺ is greater than that of Ti₃C₂Tₓ nanosheets (see the middle schematic view in FIG. 15G). As such, adsorption and reduction occur across multiple Ti₃C₂Tₓ nanosheets, leading to the formation of Pd@Ti₃C₂Tₓ precipitates (see the right schematic view in FIG. 15G). This facilitates easy recovery of the palladium.

### Experimental Example 7: Regeneration of Palladium-Adsorbed MXene Nanosheet

It was confirmed that palladium can be desorbed from Pd@Ti₃C₂Tₓ nanosheets, allowing the Ti₃C₂Tₓ nanosheet ink to be reused. Thiourea, an environmentally friendly, cost-effective eluent with excellent kinetics and selectivity, was applied to elute the adsorbed palladium.

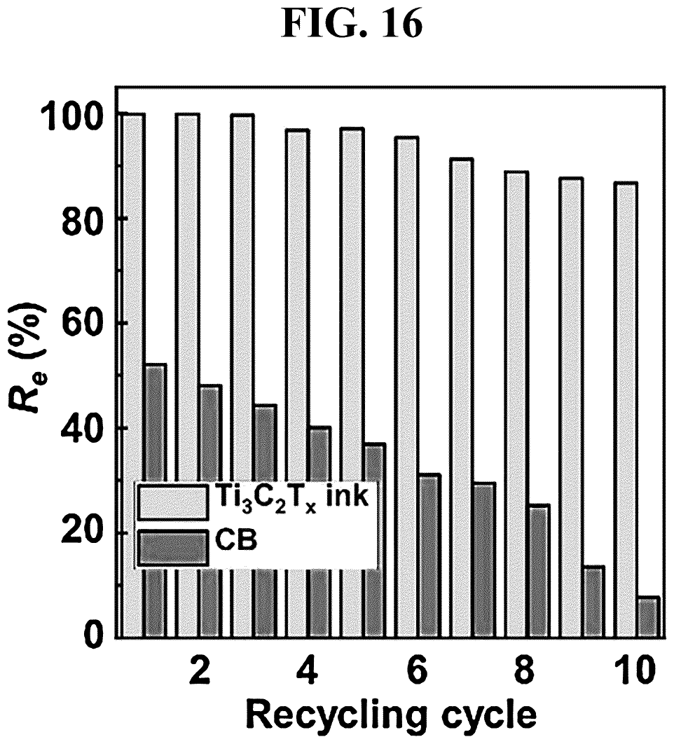

By mixing 0.3 M thiourea with 0.5 M HCl and introducing Pd@Ti₃C₂Tₓ nanosheets, it was confirmed that approximately 99.7% of the palladium was desorbed (see Table 3). The palladium-desorbed Ti₃C₂Tₓ nanosheet ink was used in palladium adsorption experiments, followed by repeated desorption of palladium. It was confirmed that the palladium recovery rate gradually decreased as the adsorption-desorption cycles were repeated (see FIG. 16). After repeating the adsorption-desorption cycle 10 times, the palladium recovery rate decreased by approximately 13%, indicating a reduction of approximately 1.3% in palladium recovery per cycle. In contrast, for carbon black (CB), the palladium recovery rate decreased by approximately 4.4% per adsorption-desorption cycle.

TABLE 3
<Palladium desorption efficiency according
to thiourea concentration>

| | | Desorption |
|---|---|---|
| Eluting | Molarity | efficiency |
| agent | (M) | (%) |
| Acidic thiourea | 0.1 | 93.2 |
| (in 0.5M HCl) | 0.2 | 96.9 |
| | 0.3 | 99.1 |
| | 0.4 | 99.7 |

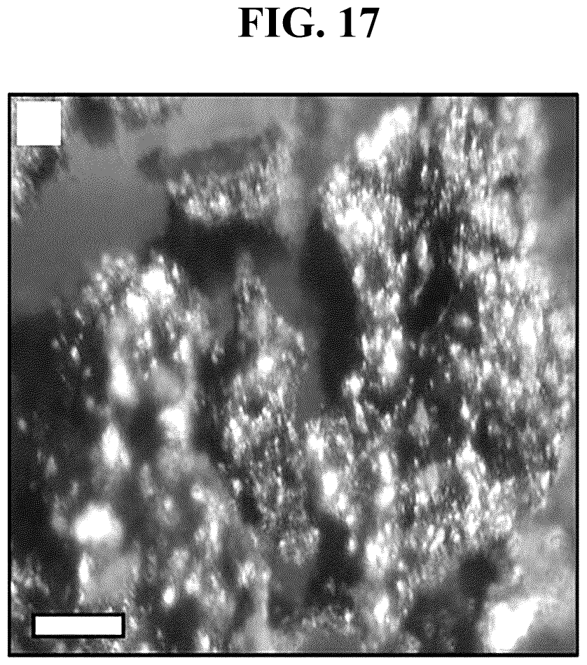

Meanwhile, the palladium desorbed from Pd@Ti₃C₂Tₓ nanosheets could be ultimately recovered by simply evaporating the solution. The palladium purity was found to be 99.9% (see FIG. 17).

### Experimental Example 8: Electrocatalytic Properties of Pd@ Ti₃C₂Ty for Hydrogen Evolution Reaction

The palladium solution concentration during palladium recovery with MXene nanosheets described in Experimental Example 3 was adjusted from 10 to 500 mg/L at pH 1 to 3. This resulted in the formation of Pd/NM (nanosheet MXene) complexes with Pd weight ratios of 5 to 62 wt % adjusted. The properties of these complexes as electrochemical catalysts for hydrogen evolution reaction (HER) were then analyzed.

To analyze the catalyst properties, a process was performed to prepare catalyst ink followed by coating onto an electrode structure. The catalyst ink was prepared by mixing 10 mg of Pd/NM, 20 μL of Nafion™ solution, and 1 mL of an ultrapure water and ethanol mixed solution. The prepared catalyst ink was coated onto a glassy carbon-based electrode using the drop casting method, manufacturing the Pd/NM catalyst working electrode.

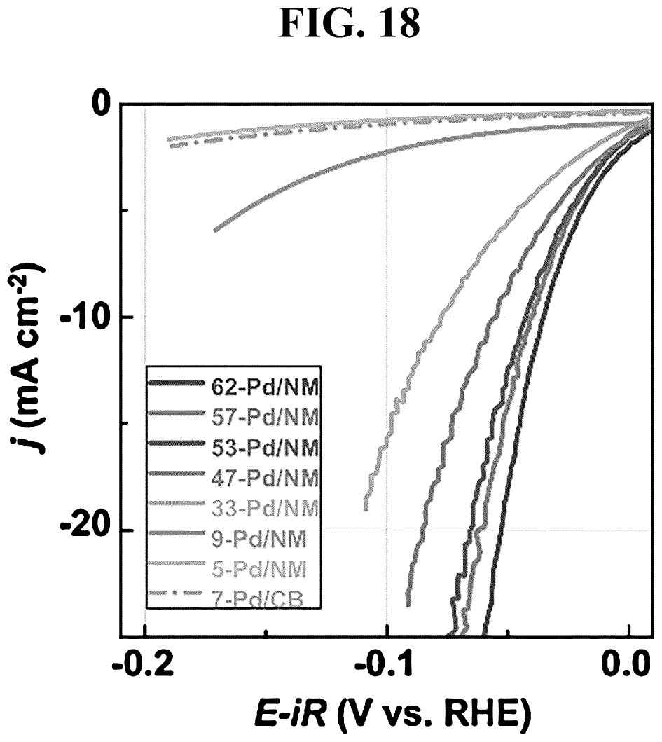

In a 0.1 M HClO₄ electrolyte, a three-electrode system was configured using the Pd/NM catalyst working electrode, a glassy carbon counter electrode, and an Ag/AgCl reference electrode. The magnitude of current density and overpotential were measured using linear sweep voltammetry (LSV). The results confirmed that the HER catalytic efficiency of Pd/NM was superior to that of the Pd complex adsorbed on carbon black (Pd/CB) (see FIG. 18).

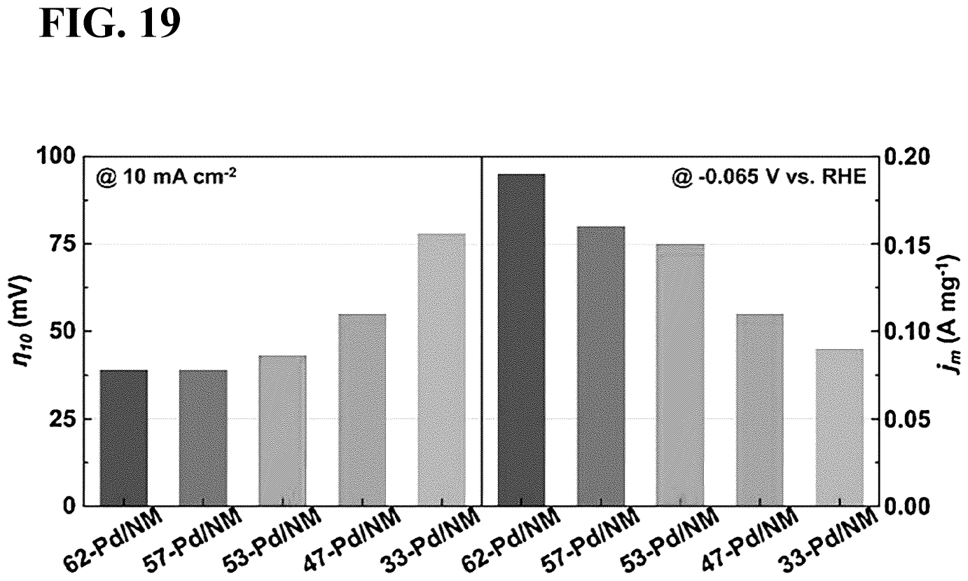

The HER overpotential and noble metal mass-specific activity of the manufactured Pd/NM catalysts were compared based on the Pd weight (see FIG. 19). The mass activity (jm), which represents noble metal mass-specific activity, was calculated by dividing the current density at −0.065 V vs. RHE by the Pd weight. It was confirmed that as the Pd weight ratio increased, the overpotential decreased, as well as the HER mass activity (jm) improved.

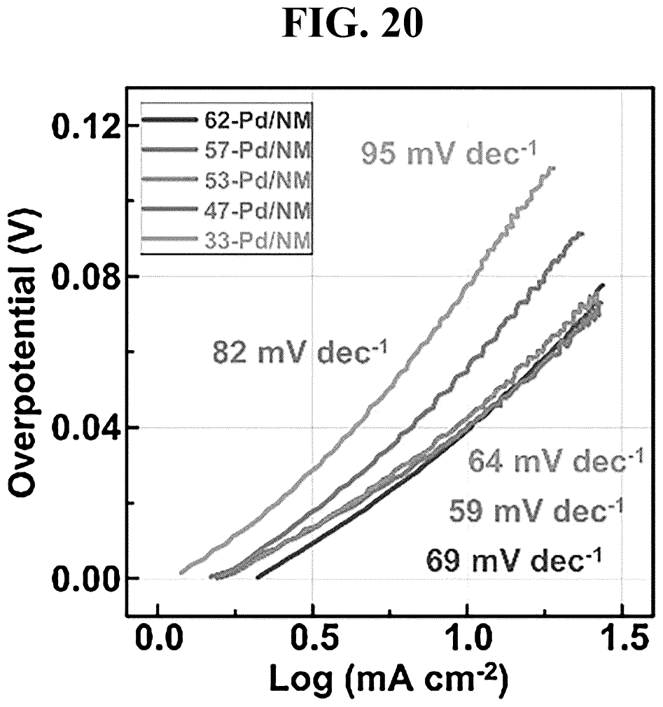

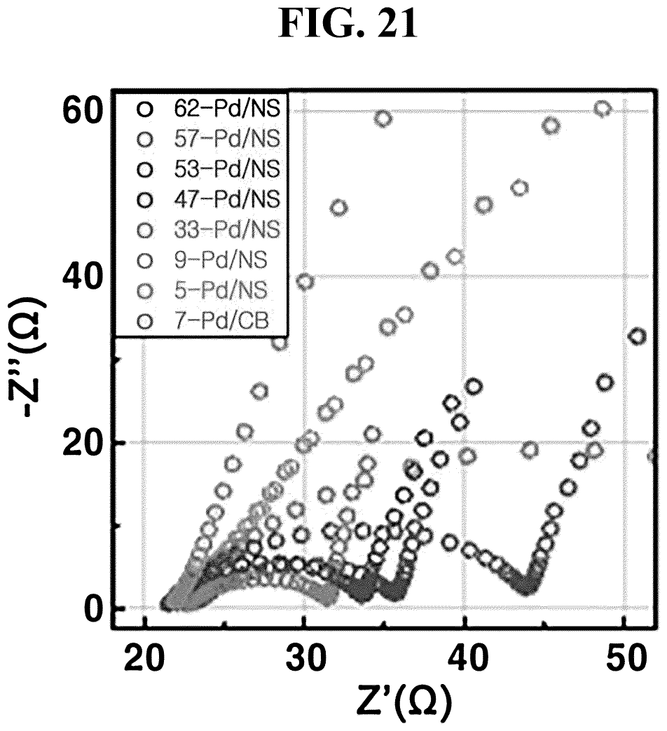

Additionally, HER Tafel slopes and electrochemical impedance analysis graphs for the manufactured Pd/NM catalysts were measured. It was confirmed that as the Pd weight ratio increased, the Tafel slope values decreased, indicating a trend of a faster HER reaction rate. The Pd/NM catalyst with a Pd weight ratio of 57 wt % (57-Pd/NM) exhibited the lowest value of 59 mV/dec (see FIG. 20). Electrochemical impedance analysis results indicated that as the Pd weight ratio increased, the amount of reduced Pd nanoparticles between Ti₃C₂Tₓ nanosheets also increased, providing a larger active area, resulting in lower charge transfer resistance (Rct) (see FIG. 21).

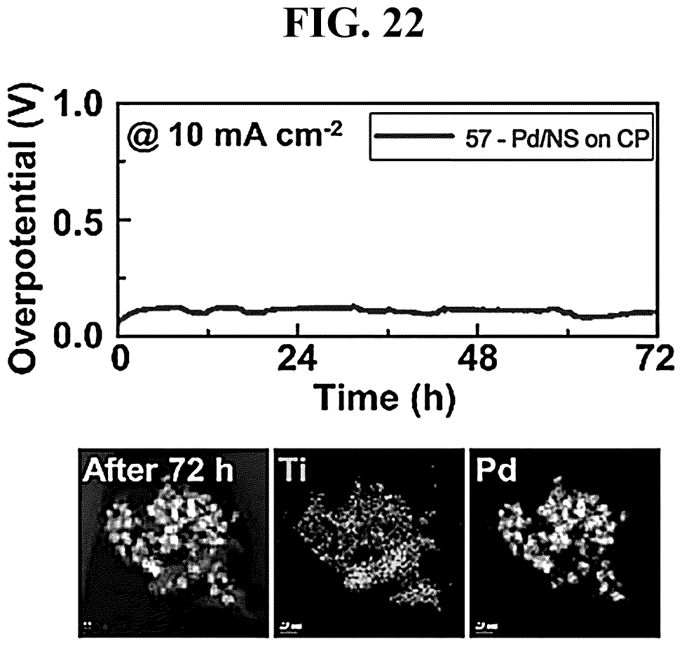

To measure the durability of the Pd/NM catalyst, constant current tests were performed for 72 hours at a constant current density of 10 mA/cm². The Pd/NM catalyst with a Pd weight ratio of 57 wt % (57-Pd/NM) maintained a stable voltage without significant voltage increase over 72 hours. These results, together with TEM images of Ti₃C₂Tₓ nanosheets and reduced Pd nanoparticles remaining stable after 72 h constant current test, indicate the stability of the Pd/NM catalyst in HER reaction (see FIG. 22).

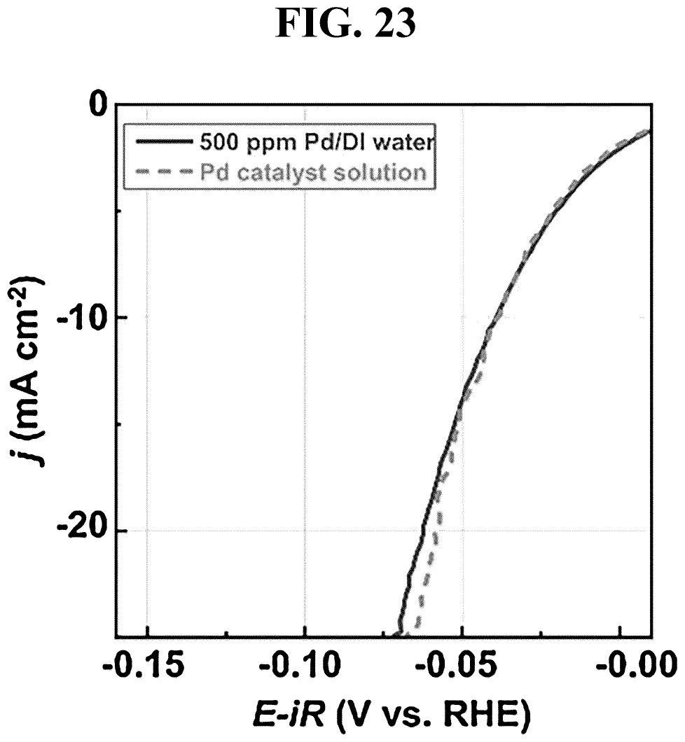

To evaluate and compare the HER characteristics of the manufactured Pd/NM catalyst and Ti₃C₂Tₓ nanosheets that recovered Pd from actual wastewater, the HER characteristics of Ti₃C₂Tₓ nanosheets with Pd respectively recovered from a palladium solution with the same Pd concentration (500 ppm) and from the waste liquid including the spent Pd catalyst used in Experimental Example 5, were compared using linear sweep voltammetry (LSV) (see FIG. 23). Due to the selective recovery performance of MXene, which adsorbs only Pd ions, it was confirmed that when manufactured into a catalyst, both solutions exhibited equivalent hydrogen evolution reaction characteristics.

What is claimed is:

1. A MXene nanosheet ink for palladium recovery, which is a solution in which MXene nanosheets of a chemical formula below are dispersed,
wherein a zeta potential (ζ) of the MXene nanosheets is 0 mV or higher in an acidic solution with a pH of 7 or below. 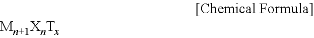
(where M is a transition metal, X is one of carbon or nitrogen or a combination thereof, T is a surface functional group and is at least one of —O, —F, —OH, or —Cl, and n is an integer from 1 to 4).

2. The MXene nanosheet ink of claim 1, wherein, in an acidic solution of pH 4 to 5, the zeta potential (ζ) of the MXene nanosheets exhibits 20 mV or higher.

3. The MXene nanosheet ink of claim 1, wherein, in an acidic solution of pH of 4 to 5, the surface functional groups present on a surface of the MXene nanosheets are protonated and saturated by hydrogen ions (H⁺).

4. The MXene nanosheet ink of claim 1, wherein, in an acidic solution of pH of 4 or lower, the surface functional groups present on a surface of the MXene nanosheets are protonated and saturated by hydrogen ions (H⁺), and the zeta potential (ζ) remains constant upon pH decrease.

5. The MXene nanosheet ink of claim 1, wherein the chemical formula is Ti₃C₂Tₓ.

6. The MXene nanosheet ink of claim 1, wherein the MXene nanosheet ink has a dispersion concentration of 2 g/L or less.

7. The MXene nanosheet ink of claim 1, wherein a maximum adsorption capacity for Pd²⁺ is 800 mg/g or more.

8. The MXene nanosheet ink of claim 1, wherein a maximum adsorption capacity for Pd²⁺ is 1000 mg/g or more.

9. The MXene nanosheet ink of claim 1, wherein a maximum adsorption capacity for Pd²⁺ is 1900 mg/g or more.
